(19) United States
(12) Patent Application Publication
(10) Pub. No.: US 2012/0120348 A1
(43) Pub. Date: May 17, 2012

(54) VA-MODE LIQUID-CRYSTAL DISPLAY DEVICE

(75) Inventor: Makoto Ishiguro, Kanagawa (JP)

(73) Assignee: FUJIFILM CORPORATION, Tokyo (JP)

(21) Appl. No.: 13/386,648

(22) PCT Filed: Jul. 23, 2010
(86) PCT No.: PCT/JP2010/063129

§ 371 Date: Jan. 23, 2012

(30) Foreign Application Priority Data
Jul. 23, 2009 (JP) 2009-172577
Oct. 2, 2009 (JP) 2009-230858
Nov. 30, 2009 (JP) 2009-272886

(51) Int. Cl. G02F 1/1335

(52) U.S. Cl. 349/96

(57) ABSTRACT

A VA-mode liquid-crystal display device comprising a front-side polarizing element, a rear-side polarizing element, a liquid-crystal layer disposed between the front-side polarizing element and the rear-side polarizing element, and a color filter disposed between the liquid-crystal layer and the rear-side polarizing element, wherein one or more retardation layers disposed between the rear-side polarizing element and the color filter layer (hereinafter the whole of one or more retardation layers disposed between the rear-side polarizing element and the color filter layer is referred to as “rear-side retardation region”) satisfies, as a whole, |Rth(590)|≦90 nm, is disclosed.

### TECHNICAL FIELD

The present invention relates to a VA (vertically aligned)-mode liquid-crystal display device improved in the front contrast ratio.

### BACKGROUND ART

These days elevation of the contrast ratio (CR) in liquid-crystal display devices is being promoted. In particular, a VA-mode liquid-crystal display device has the advantage that CR in the normal direction (hereinafter referred to as “front CR”) is high as compared with that in other modes, and various studies and developments are now made for further enhancing the advantage. As a result, in these 6 years, the front CR in VA-mode liquid-crystal display devices has increased from about 400 to about 8000, or by about 20 times.

For example, as one means of increasing transmittance, there is known a color filter on array (COA) structure (for example, Patent References 1, 2 and 3). In the COA structure, the numerical aperture can be large, and therefore the transmittance at the time of white level of display can be increased. At present, environmental problems are of particularly high interest to the public, and increasing transmittance by employing such a COA structure could contribute toward reducing power consumption and is favorable from the viewpoint of environmental issues. The front CR is determined by two transmittances, that at the time of white level of display and that at the time of black level of display (white brightness and black brightness), and therefore the front CR could not be improved by mere increase in transmittance. Even though the transmittance at the time of white level of display could be increased, but when the transmittance at the time of black level of display is increased at the same time, then high CR could not be attained. In order to increase the front CR by employing a structure capable of improving the transmittance at the time of white level of display, it is important to control the increase in the black transmittance in employing the structure.

On the other hand, in liquid-crystal display devices, it is important that not only the front CR is high but also CR in oblique directions (hereinafter this may be referred to as “viewing angle CR”) is high. Various techniques of using a retardation film have been proposed for reducing the light leakage in oblique directions at the time of black level of display in VA-mode liquid-crystal display devices (for example, Patent Reference 4). In general, a retardation film is disposed on both the front side and the rear side of the liquid-crystal cell existing in the center therebetween, in which the two retardation films share the retardation necessary for optical compensation in the display device. In general, two systems are employed for the combination for optical compensation. In one system, the retardation films each separately disposed on the front side and on the rear side equally share the same retardation; and the advantage of the system is that the films of the same type can be used therein. In the other system, the retardation film disposed on either one side is made to share a larger retardation; and the system is advantageous in point of the cost since it enables optical compensation by the use of a combination of inexpensive retardation films. In the latter system, in general, the retardation film to be disposed on the rear side is made to share a larger retardation in practical use. One reason is the production cost. Regarding this reason, Patent Reference 5 says as follows: “In case where the cellulose acylate film of the invention is used only as the protective film of one polarizer (between the liquid-crystal cell and the polarizing film), this may be on either side of the upper polarizer (viewers' side) or the lower polarizer (backlight side) with no functional problem. However, when it is used on the side of the upper polarizer, the functional film must be provided on the viewers' side (upper side) and the producibility may be thereby lowered, and therefore, it may be used on the side of the lower polarizer in many cases, and this may be a more preferred embodiment.” The second reason is that arranging the film having a larger retardation on the rear side is preferred from the viewpoint of the impact resistance and the resistance to environmental change including temperature change and humidity change.

### PRIOR ART REFERENCES

### Patent References

[Patent Reference 1] JP-A 2005-99499
[Patent Reference 2] JP-A 2005-258004
[Patent Reference 3] JP-A 2005-3733
[Patent Reference 4] JP-A 2006-184640
[Patent Reference 5] JP-A 2006-241293, [0265]

### SUMMARY OF THE INVENTION

### Problems that the Invention is to Solve

The present inventors have tried improving the front CR by employing a COA structure in a VA-mode liquid-crystal display device, but have known that the front CR could not be improved by it. As a result of further investigations, the inventors have known that one reason is the existence of the retardation film that contributes toward reducing the light leakage occurring in oblique directions at the time of black level of display of the VA-mode liquid-crystal display device, or that is, toward improving the viewing angle CR in the display device. In particular, it has been known that, in case where the VA-mode liquid-crystal display device having the above-mentioned general constitution where a retardation film having a large retardation level is disposed on the rear side has a COA structure incorporated therein, then not only the front CR is not improved but also it rather worsens. So far as the present inventors have known, it may be said that nothing has heretofore been known relating to the problem in employing the COA structure in a VA-mode liquid-crystal display device having a retardation film.

Specifically, an object of the present invention is to solve the problem in employing a COA structure in a VA-mode liquid-crystal display device having a retardation film. Concretely, an object of the invention is to provide a COA structure-having VA-mode liquid-crystal display device improved in point of the front contrast ratio thereof.

### Means for Solving the Problems

As described above, the present inventors have found as a result of assiduous investigations that, when a COA structure is employed, the numerical aperture is expanded, and therefore the transmittance at the time of white level of display could increase, but on the other hand, the light leakage at the time of black level of display also increases. In particular, it has been found that, in case where a COA structure is employed in a VA-mode liquid-crystal display device with a retardation film having a large retardation level disposed on the rear side, then not only the front CR is not improved but also the front CR rather decreases more than that not having the COA structure therein. To solve the problems, the present inventors have variously investigated and, as a result, have found that, when the total Rth of the retardation film disposed on the rear side is within a predetermined range, then the front CR of the COA structure-having VA-mode liquid-crystal display device can be dramatically improved, and have completed the present invention.

Namely, the means for achieving the above mentioned objects are as follows.

[1] A VA-mode liquid-crystal display device comprising a front-side polarizing element, a rear-side polarizing element, a liquid-crystal layer disposed between the front-side polarizing element and the rear-side polarizing element, and a color filter disposed between the liquid-crystal layer and the rear-side polarizing element, wherein one or more retardation layers disposed between the rear-side polarizing element and the color filter layer (hereinafter the whole of one or more retardation layers disposed between the rear-side polarizing element and the color filter layer is referred to as “rear-side retardation region”) satisfies, as a whole, the following formula (I):

|Rth(590)|≦90 nm, (I)

wherein Rth(λ) means a retardation (nm) in the thickness direction at a wavelength of λ nm.
[2] The VA-mode liquid-crystal display device of [1], wherein the liquid-crystal layer is sandwiched between an array substrate having a black matrix that partitions the pixel having the color filter layer, and the counter substrate disposed to face the array substrate.
[3] The VA-mode liquid-crystal display device of [1] or [2], wherein the rear-side retardation region satisfies the following formula (II):

|Re(590)|≦20 nm (II)

wherein Re(λ) means an in-plane retardation (nm) at a wavelength of λ nm.
[4] The VA-mode liquid-crystal display device of any one of [1] 1 to [3], wherein one or more retardation layers disposed between the front-side polarizing element and the liquid-crystal layer (hereinafter the whole of one or more retardation layers disposed between the front-side polarizing element and the liquid-crystal layer is referred to as “front-side retardation region”) satisfies, as a whole, the following formulae (III) and (IV):

30 nm≦Re(590)≦90 nm, (III)

150 nm≦Rth(590)≦300 nm. (IV)

[5] The VA-mode liquid-crystal display device of any one of [1] to [4], wherein the rear-side retardation region satisfies the following formula (Ia):

|Rth(590)|≦20 nm. (Ia)

[6] The VA-mode liquid-crystal display device of [5], wherein the front-side retardation region satisfies the following formulae (IIIa) and (IVa):

30 nm≦Re(590)≦90 nm, (IIIa)

180 nm≦Rth(590)≦300 nm. (IVa)

[7] The VA-mode liquid-crystal display device of any one of [1] to [4], wherein the rear-side retardation region satisfies the following formula (Ib):

20 nm<Rth(590)≦90 nm. (Ib)

[8] The VA-mode liquid-crystal display device of [7], wherein the front-side retardation region satisfies the following formulae (IIIb) and (IVb):

30 nm≦Re(590)≦90 nm, (IIIb)

150 nm≦Rth(590)≦270 nm. (IVb)

[9] The VA-mode liquid-crystal display device of any one of [1] to [8], wherein the rear-side retardation region is formed of a cellulose acylate film or comprises a cellulose acylate film.
[10] The VA-mode liquid-crystal display device of any one of [1] to [9], wherein the rear-side retardation region is formed of an acrylic polymer film or comprises an acrylic polymer film.
[11] The VA-mode liquid-crystal display device of [10], wherein the rear-side retardation region is formed of an acrylic polymer film containing an acrylic polymer containing at least one unit selected from a lactone ring unit, a maleic anhydride unit, and a glutaric anhydride unit, or comprises that type of an acrylic polymer film.
[12] The VA-mode liquid-crystal display device of any one of [1] to [10], wherein the rear-side retardation region is formed of a cycloolefin polymer film or comprises a cycloolefin polymer film.
[13] The VA-mode liquid-crystal display device of any one of [1] to [12], wherein the front-side retardation region is formed of one biaxial polymer film or comprises one biaxial polymer film.
[14] The VA-mode liquid-crystal display device of any one of [1] to [13], wherein the front-side retardation region comprises one monoaxial polymer film.
[15] The VA-mode liquid-crystal display device of [13] or [14], wherein the biaxial polymer film or the monoaxial polymer film is a cellulose acylate film.
[16] The VA-mode liquid-crystal display device of [13] or [14], wherein the biaxial polymer film or the monoaxial polymer film is a cycloolefin polymer film.
[17] The VA-mode liquid-crystal display device of any one of [1] to [16], wherein Re and Rth of the rear-side retardation region have reversed wavelength dispersion characteristics of retardation or are constant irrespective of wavelength, in a visible light wavelength region.

### Effect of the Invention

According to the present invention, it is possible to provide a COA structure-having VA-mode liquid-crystal display device improved in point of the front contrast ratio thereof.

### BRIEF DESCRIPTION OF THE DRAWINGS

FIG. 1 is a schematic cross-sectional view of one example of the VA-mode liquid-crystal display device of the invention.

FIG. 2 is a schematic cross-sectional view of one example of a non-COA structured VA-mode liquid-crystal display device given herein for reference.

### DESCRIPTION OF REFERENCE NUMERALS AND SIGNS

10 Liquid-crystal layer
12 Color filter layer
14 Array member
16 Rear-side substrate
18 Front-side substrate
20 Rear-side retardation region
22 Front-side retardation region
24 Rear-side polarizing element
26 Front-side polarizing element
28 Backlight unit
LC COA-structured VA-mode liquid-crystal cell
PL1 Rear-side polarizer
PL2 Front-side polarizer

### MODE FOR CARRYING OUT THE INVENTION

The invention is described in detail hereinunder. Note that, in this patent specification, any numerical expressions in a style of “ . . . to .” will be used to indicate a range including the lower and upper limits represented by the numerals given before and after “to”, respectively.

At first, the terms used in the description will be explained.

### (Retardation, Re and Rth)

In this description, Re(λ) and Rth(λ) are retardation in plane (nm) and retardation along the thickness direction (nm), respectively, at a wavelength of λ. Re(λ) is measured by applying light having a wavelength of λ nm to a sample such as a film in the normal direction thereof, using KOBRA 21ADH or WR (by Oji Scientific Instruments). The standard wavelength of KOBRA is 590 nm.

When a sample to be analyze by a monoaxial or biaxial index ellipsoid, Rth(λ) of the film is calculated as follows.

Rth(λ) is calculated by KOBRA 21ADH or WR based on six Re(λ) values which are measured for incoming light of a wavelength λ nm in six directions which are decided by a 10° step rotation from 0° to 50° with respect to the normal direction of a sample film using an in-plane slow axis, which is decided by KOBRA 21ADH, as an tilt axis (a rotation axis; defined in an arbitrary in-plane direction if the film has no slow axis in plane); a value of hypothetical mean refractive index; and a value entered as a thickness value of the film.

In the above, when the film to be analyzed has a direction in which the retardation value is zero at a certain tilt angle, around the in-plane slow axis from the normal direction as the rotation axis, then the retardation value at the tilt angle larger than the tilt angle to give a zero retardation is changed to negative data, and then the Rth(λ) of the film is calculated by KOBRA 21ADH or WR.

Around the slow axis as the tilt angle (rotation angle) of the film (when the film does not have a slow axis, then its rotation axis may be in any in-plane direction of the film), the retardation values are measured in any desired tilted two directions, and based on the data, and the estimated value of the mean refractive index and the inputted film thickness value, Rth may be calculated according to the following formulae (X) and (XI):

$$\begin{matrix}Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} & ( X ) \\ Rth = ( \frac{nx + ny}{2} - nz ) \times d & ( XI )\end{matrix}$$

wherein Re(θ) represents a retardation value in the direction tilted by an angle θ from the normal direction; nx represents a refractive index in the in-plane slow axis direction; ny represents a refractive index in the in-plane direction perpendicular to nx; and nz represents a refractive index in the direction perpendicular to nx and ny. And “d” is a thickness of the sample.

When the sample such as a film to be analyzed is not expressed by a monoaxial or biaxial index ellipsoid, or that is, when the film does not have an optical axis, then Rth(λ) of the film may be calculated as follows:

Re(λ) of the film is measured around the slow axis (judged by KOBRA 21ADH or WR) as the in-plane tilt axis (rotation axis), relative to the normal direction of the film from −50 degrees up to +50 degrees at intervals of 10 degrees, in 11 points in all with a light having a wavelength of λ nm applied in the tilted direction; and based on the thus-measured retardation values, the estimated value of the mean refractive index and the inputted film thickness value, Rth(λ) of the film may be calculated by KOBRA 21ADH or WR.

In the above-described measurement, the hypothetical value of mean refractive index is available from values listed in catalogues of various optical films in Polymer Handbook (John Wiley & Sons, Inc.). Those having the mean refractive indices unknown can be measured using an Abbe refract meter. Mean refractive indices of some major optical films are listed below:

cellulose acylate (1.48), cycloolefin polymer (1.52), polycarbonate (1.59), polymethylmethacrylate (1.49) and polystyrene (1.59).

KOBRA 21ADH or WR calculates nx, ny and nz, upon enter of the hypothetical values of these mean refractive indices and the film thickness. Base on thus-calculated nx, ny and nz, Nz=(nx−nz)/(nx−ny) is further calculated.

In this description, the values of Re(λ) and Rth(λ) such as Re(450), Re(550), Re(630), Rth(450), Rth(550) and Rth(630) are computed from the data of Re and Rth measured with a measuring device at three or more different wavelengths (e.g., λ=479.2, 546.3, 632.8 or 745.3 nm). Concretely, the measured values are approximated by the Cauchy's formula (up to the 3rd term, Re=A+B/λ²+C/λ⁴) to determine the values A, B and C. In that manner, the data of Re and Rth at a wavelength of λ are replotted, from which Re(λ) and Rth(λ) at the wavelength λ may be thereby determined.

In this description, the “slow axis” of the retardation film and others means the direction in which the refractive index is the largest. The “visible light region” is from 380 nm to 780 nm. Unless otherwise specifically indicated in this description, the measurement wavelength is 590 nm. The wavelength 590 nm is one generally employed in control of the physical data of films in the technical field to which the present invention belongs.

In this description, it should be so interpreted that the numerical data, the numerical range and the qualitative expression (for example, expression of “equivalent”, “equal” or the like) indicating the optical properties of the constitutive members such as the retardation region, the retardation film, the liquid-crystal layer and others shall be the numerical data, the numerical range and the qualitative properties including generally acceptable errors regarding the liquid-crystal display device and the constitutive members thereof.

In this description, the retardation film means a self-supporting film disposed between a liquid-crystal cell and a polarizing element, irrespective of the level of retardation thereof. The retardation membrane, the retardation layer, the retardation film have the same meaning. The retardation region is a generic term for one or more retardation film layers disposed between a liquid-crystal cell and a polarizing element.

In this description, the “front side” means the panel side; and the “rear side” means the backlight side. In this description, the “front” means the normal direction to the panel face; and the “front contrast ratio (CR)” means the contrast ratio computed from the white brightness and the black brightness measured in the normal direction to the panel face; and the “viewing angle contrast ratio (CR)” means the contrast ratio computed from the white brightness and the black brightness measured in the oblique directions inclined from the normal direction relative the panel face (for example, in the direction defined at an azimuth direction of 45 degrees and a polar angle direction of 60 degrees relative to the panel face).

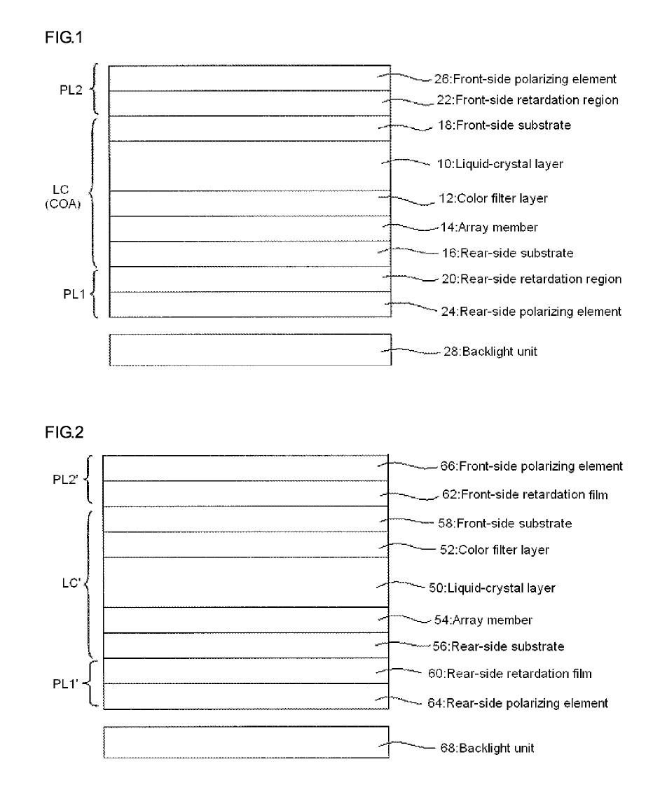

The present invention relates to a VA-mode liquid-crystal display device having a COA structure. FIG. 1 shows a schematic cross-sectional view of one example of the liquid-crystal display device of the invention; and FIG. 2 shows a schematic cross-sectional view of a non-COA-structured VA-mode liquid-crystal display device given for reference.

The VA-mode liquid-crystal display device of the invention shown in FIG. 1 comprises a front-side polarizing element 26, a rear-side polarizing element 24, a liquid-crystal layer 10 disposed between the front-side polarizing element 26 and the rear-side polarizing element 24, a color filter layer 12 disposed between the liquid-crystal layer 10 and the rear-side polarizing element 24, a rear-side retardation region 20 disposed between the rear-side polarizing element 24 and the color filter layer 12, and a front-side retardation region disposed between the front-side polarizing element 26 and the liquid-crystal display layer 10. The liquid-crystal cell LC that the VA-mode liquid-crystal display device of FIG. 1 has is a COA-structured liquid-crystal cell in which the liquid-crystal layer 10 is sandwiched between a front-side substrate 18 and a rear-side substrate 16, and an array member 14 and the color filter layer 12 are on one and the same substrate, or that is, on the rear-side substrate 16. The liquid-crystal cell LC may have a black matrix (not shown), and its position may be on the rear-side substrate 16 or on the front-side substrate 18.

FIG. 2 is a reference example, and is a schematic cross-sectional view of one example of a VA-mode liquid-crystal display device having a non-COS-structured liquid-crystal cell LC′. In FIG. 2, the liquid-crystal cell LC′ is a non-COS-structured liquid-crystal cell comprising a liquid-crystal layer 50 sandwiched between a front-side substrate 58 and a rear-side substrate 56, and comprising a color filter layer 52 disposed on the front-side substrate 58 differing from the substrate on which an array member 54 is disposed.

The VA-mode liquid-crystal display devices of FIG. 1 and FIG. 2 are described with reference to the reason for increasing the transmittance in the front direction at the time of black level of display, or that is, increasing light leakage.

In general, at the time of black level of display in a VA-mode liquid-crystal display device, the liquid-crystal layer (10 or 50) is in a vertical alignment state, and therefore, of the linear polarized light having passed through the rear-side polarizing element (24 or 64) and running in the normal direction, the polarization state does not change even after it passes through the liquid-crystal layer (10 or 50), and in principle, it is all absorbed by the absorption axis of the front-side polarizing element (26 or 66). Specifically, in principle, it may be said that there is no light leakage at the time of black level of display. However, the front transmittance at the time of black level of display of a VA-mode liquid-crystal display device is not zero. It is known that one reason is because the liquid-crystal molecules in the liquid-crystal layer (10 or 50) fluctuate, and the incident light running in the liquid-crystal layer is scattered in some degree owing to the fluctuation. In case where the incident light running in the liquid-crystal layer (10 or 50) contains more completely only the linear polarized light component to be absorbed by the absorption axis of the front-side polarizing element (26 or 66), its influence could be larger and the front light leakage tends to increase. In other words, in case where the retardation of the retardation region (20 or 60) disposed on the rear side is larger and when the incident light is converted to an elliptically-polarized light at a higher degree of elliptical polarization, then the front light leakage owing to fluctuation could be reduced more.

As described above, however, the present inventors' investigations have clarified that the retardation of the retardation film (20 or 60) disposed between the rear-side polarizing element (24 or 64) and the liquid-crystal layer (10 or 60) contributes to another reason for the above, in addition to the fluctuation of the liquid-crystal molecules in the liquid-crystal layer. When a directional light from the backlight (28 or 68) has passed through the rear-side polarizing element (24 or 64) and comes in the retardation film (20 or 60) in an oblique direction thereto, then the linear polarized light is converted to an elliptically-polarized light owing to the retardation. The elliptically-polarized light is diffracted or scattered by the array member (14 or 54) and the color filter layer (12 or 52) in the liquid-crystal cell, and at least a part thereof becomes a light running in the front direction. Since the elliptically-polarized light contains a linear polarized light component that could not be blocked by the absorption axis of the front-side polarizing element (26 or 66), there still occurs light leakage in the front direction even at the time of black level of display, which causes a reason of front CR reduction. The optical phenomenon to occur through light passage through the array member (TFT array or the like) or the color filter layer is, for example, caused by the reason that the surface of the array member and the color filter is not completely flat and smooth but is roughened in some degree, and that the member may contain a scattering factor or the like. The influence of the optical phenomenon to occur through light passage through the array member and the color filter layer on the light leakage in the front direction is larger than the influence thereon of the fluctuation of the liquid-crystal molecules in the liquid-crystal layer mentioned above.

Further, the present inventors' investigations have clarified that the optical phenomenon (diffraction, scattering or the like) that the light having become elliptically-polarized light through passing through the retardation film shall undergo in passing through a predetermined member in the liquid-crystal cell differs in point of the state thereof to have an influence on the light leakage in the front direction, depending on whether the light may pass through that member before coming in the liquid-crystal layer or the light may pass that member after having passed through the liquid-crystal layer. In any constitution of FIG. 1 and FIG. 2, light passes through the array member (14 or 54) before coming in the liquid-crystal layer (10 or 50). On the other hand, in the COA structure shown in FIG. 1, light passes through the color filter layer (12) before passing through the liquid-crystal layer (10); but in the non-COA structure shown in FIG. 2, light passes through the color filter layer (52) after having passed through the liquid-crystal layer (50).

In case where an elliptically-polarized light having a smaller degree of elliptical polarization comes in the array member and the color filter layer, the influence of the optical phenomenon to be caused by the light passage through the corresponding member on the light leakage in the front direction may correspondingly be reduced more.

Accordingly, for reducing the light leakage owing to the optical phenomenon in the array member, an elliptically-polarized light having a smaller degree of elliptical polarization shall come in the member; and in a case of a COA structure, the light leakage owing to the optical phenomenon in the color filter layer could be thereby reduced at the same time.

In the member through which light passes before it comes in the liquid-crystal layer, the degree of elliptical polarization of the incident light is determined by the retardation of the rear-side retardation region (20 or 60) through which the light previously passes. On the other hand, in the member through which light passes after it has come in the liquid-crystal layer, the degree of elliptical polarization of the incident light is determined by the retardation of the liquid-crystal layer in addition to the retardation of the rear-side retardation region (20 or 60). In a case of VA-mode liquid-crystal display device, when the switching between white-level display and black-level display is taken into consideration, in general, Δnd(590) of the liquid crystal layer is defined to be between 280 and 350 nm or so. In this, d means the thickness (nm) of the liquid-crystal layer, Δn(λ) means a refractive index anisotropy at a wavelength of L of the liquid-crystal layer, and Δnd(λ) means a product of Δn(λ) and d. In a case of non-COA structure, even though the retardation of the rear-side retardation region is so defined that the light leakage through the array member could reduce, the degree of elliptical polarization of the elliptically-polarized light having passed through the liquid-crystal layer may rather increase on the contrary, and as a result, the light leakage owing to the optical phenomenon to be caused by the light passage through the color filter or the like member increases. The level of the retardation of the rear-side retardation region (20 or 60), the tendency of the influence of the light passage through the constitutive members on the front-direction light leakage, and the level of the influence are summarized as in the following Table.

TABLE 1

| | | Reduction in | Increase in | Relative |
|---|---|---|---|---|
| | Light | Retardation of | Retardation of | Relationship of the |
| | Running | Rear-Side | Rear-Side | Level of Influence |
| | Route | Retardation Region | Retardation Region | on Light Leakage |
| COA-Structured | | | | |
| Liquid-Crystal Cell | | | | |
| of FIG. 1 | | | | |
| Liquid-Crystal | 3 | Act to increase light | Act to decrease | weakest |
| Layer | | leakage. | light leakage. | |
| Color Filter Layer | 2 | Act to decrease | Act to increase light | strong |
| | | light leakage. | leakage. | |
| Array Member | 1 | Act to decrease | Act to increase light | strongest |
| | | light leakage. | leakage. | |
| Non-COA- | | | | |
| Structured | | | | |
| Liquid-Crystal Cell | | | | |
| of FIG. 2 | | | | |
| Color Filter Layer | 3 | Act to increase light | Act to decrease | strong |
| | | leakage. | light leakage. | |
| Liquid-Crystal | 2 | Act to increase light | Act to decrease | weakest |
| Layer | | leakage. | light leakage. | |
| Array Member | 1 | Act to decrease | Act to increase light | strongest |
| | | light leakage. | leakage. | |

As in the above Table, in the VA-mode liquid-crystal display device having a non-COA structured liquid-crystal cell, when the retardation of the rear-side retardation film (60) is reduced, then the light leakage in the front direction to be caused by the optical phenomenon of the array member (54) may tend to decrease, but the light leakage in the front direction to be caused by the optical phenomenon of the color filter layer (52) may tend to increase, and when the retardation of the rear-side retardation film (60) is increased, then the light leakage in the front direction to be caused by the optical phenomenon of the array member (54) may tend to increase, but the light leakage in the front direction to be caused by the optical phenomenon of the color filter layer (52) may tend to decrease; or in other words, the two actions are in an offset relation from each other. Accordingly, in the non-COA structure, the level of the retardation of the rear-side retardation film has little influence on the front CR; and in the non-COA structured VA-mode liquid-crystal display device, there is no necessity of investigating the retardation level of the rear-side retardation film in view of the front CR. Specifically, in the non-COA structure, even though the rear-side retardation film is made to have a higher retardation level, the problem of front CR reduction is not actualized; and therefore, as so described above, a constitution where the rear-side retardation film is made to have a higher retardation level has been put into practical use, in consideration of the production cost, the impact resistance and the environment resistance.

On the other hand, as shown in the above Table, in the VA-mode liquid-crystal display device having a COA-structured liquid-crystal cell of FIG. 1, when the retardation level in the rear-side retardation region (20) is reduced, then the light leakage in the front direction to be caused by the optical phenomenon of the array member (14) can reduce, and the light leakage in the front direction to be caused by the optical phenomenon of the color filter layer (12) can also reduce; but on the contrary, when the retardation level in the rear-side retardation region (20) is increased, then the light leakage in the front direction to be caused by the optical phenomenon of the array member (14) tends to increase and the light leakage in the front direction to be caused by the optical phenomenon of the color filter layer (12) also tends to increase. Accordingly, even when a COA structure is employed and the numerical aperture is expanded in the latter constitution, the front light leakage at the time of black level of display increases owing to the optical phenomenon in light passage through the array member and the color filter layer, and therefore the front CR could not be improved but rather the front CR may lower. As far as the present inventors know, heretofore no one knows this problem.

The influence of the retardation of the rear-side retardation region on the front CR is almost ignorable in a liquid-crystal display device having a low front CR. However, in a liquid-crystal display device having a high front CR (for example, having a front CR of at least 1500) that has become provided recently, the influence is not ignorable for further improving the front CR of the device. The invention is especially useful for further improving the front CR of such a liquid-crystal display device having a front CR of at least 1500.

The front CR-improving effect of the invention is not an effect caused by employing a COA-structured liquid-crystal cell and by increasing the numerical aperture, as so mentioned in the above, but is caused by making the rear-side retardation region of a COA-structured liquid-crystal cell have a lower retardation level to thereby reduce the scattering of the polarized light to come in the liquid-crystal cell and therefore to lower the front-side black brightness. In case where the effect of the invention is presumed such that the polarized light having entered the liquid-crystal cell could still maintain its polarization state even after having been scattered by the inner constitutive members, this can be explained by the trajectory of light polarization on a Poincare sphere. On the other hand, heretofore, it has not been so considered that, when a polarized light is scattered, it could maintain its polarized state; and therefore, it is not predictable that the effect of the invention having solved the problem of front CR reduction owing to the light scattering in a liquid-crystal cell can be explained by the trajectory of light polarization on a Poincare sphere.

Not only the front CR, but also the front color at the time of black level of display (front black color) is also an important display characteristic of a liquid-crystal display device. The present inventors' investigations have revealed that when the retardation (Re and Rth) in the rear-side retardation region of a COA-structured liquid-crystal cell may be larger at a longer wavelength in a visible light region, or that is, the rear-side retardation region has reversed wavelength dispersion characteristics of retardation, then the discoloration of the front-side black color into a specific color can be reduced. The reason may be considered in the same manner as that for the light leakage in the front direction in a liquid-crystal display device described in the above. Specifically, when the reversed wavelength dispersion characteristics of retardation in the rear-side retardation region are stronger, then the wavelength dependence of the elliptical polarization of the incident light in oblique directions from the light source (backlight) of the liquid-crystal display device can be reduced more and, as a result, the difference in the light leakage level between different wavelengths can be reduced and the discoloration of the front-side black color into a specific color can be thereby reduced.

The inventors have further investigated and have known that, in a COA-structured liquid-crystal cell, the front-side discoloration at the time of black level of display can be reduced more as compared with that in a non-COA-structured liquid-crystal cell. The reason is because in the non-COA-structured liquid-crystal cell, the light scattering in the member on the front-side substrate, on which the retardation of the liquid-crystal layer has a significant influence, must be taken into consideration. The incident light to a non-COA-structured liquid-crystal cell passes through the liquid-crystal layer before it is scattered in the member on the front-side substrate. The retardation of the liquid-crystal layer, or that is, Δnd(λ) thereof has regular wavelength dispersion characteristics (in that the retardation is smaller at a longer wavelength); and therefore, when the incident light passes through the liquid-crystal layer, the degree of elliptical polarization of the light in the shorter wavelength region is larger, and as a result, the light in a blue region tends to be leaked more readily. Accordingly, in the COA-structured liquid-crystal cell where the influence of light scattering on the member on the front-side substrate is small, the front-side discoloration at the time of black level of display can be reduced more as compared with that in the non-COA-structured liquid-crystal cell.

When the rear-side retardation region in a COA-structured liquid-crystal cell is made to have a lower retardation level and have a reversed wavelength dispersion characteristics of retardation, then the front-side discoloration at the time of black level of display can also be reduced.

More concretely, when the rear-side retardation region of the COA-structured liquid-crystal cell is made to have a low retardation and to have reversed wavelength dispersion characteristics of retardation, then the front-side discoloration at the time of black level of display, as compared with an embodiment where the rear-side retardation region of the COA-structured liquid-crystal cell has also a low retardation but has regular wavelength dispersion characteristics. In the latter case, somewhat bluish discoloration is seen; but in the former case, bluish discoloration is seen little. On the u′ v′ chromaticity diagram, v′ for black is preferably at least 0.375. On the u′ v′ chromaticity diagram, the bluish discoloration at the time of black level of display means the reduction in the value v′. In the former embodiment, v′ for black can be at least 0.38.

The embodiment where the rear-side retardation region of the COA-structured liquid-crystal cell has a low retardation contributes toward improving not only the front-side CR but also the contrast ratio in oblique directions (hereinafter this may be referred to as “viewing angle CR”). For example, even though a COA-structured liquid-crystal cell is employed, both the front CR and the viewing angle CR could not be improved when the rear-side retardation region has a high retardation as in the prior art. Specifically, the effect of the invention of improving the viewing angle CR can be attained by reducing the light leakage that fluctuates owing to the incident polarized light running into a liquid-crystal cell, but could not by employing the COA-structured liquid-crystal cell and increasing the numerical aperture.

The effect of the invention is differentiated from the viewing angle CR-improving effect of the front-side retardation region to be mentioned hereinunder, which compensates the shifting of the polarization axes of a pair of polarizers from perpendicular configuration thereof.

Like the front CR-improving effect thereof, the viewing angle CR-improving effect of the invention can also be explained by the trajectory of light polarization on a Poincare sphere in case where the incident polarized light running into a liquid-crystal cell could still maintain its polarization state even after having been scattered by the inner constitutive members. On the other hand, as described above, heretofore it has not been so considered that, when a polarized light is scattered, it could maintain its polarized state; and therefore, it is not predictable that the effect of the invention having solved the problem of front CR reduction owing to the light scattering in a liquid-crystal cell can be explained by the trajectory of light polarization on a Poincare sphere.

Surprisingly, assiduous investigations made by the present inventors have clarified that the above problems could be solved by making the rear-side retardation region (20 in FIG. 1), through which light passes before coming in a COA-structured liquid-crystal cell, satisfy the following formula (I):

|Rth(590)|≦90 nm. (I)

So far as the retardation of the entire retardation region, through which light passes before coming in a COA-structured liquid-crystal cell LC, satisfies the above formula (I), the front-direction light leakage at the time of black level of display is not excessively increased even though the incident light in an oblique direction is afterwards scattered or refracted by the array member 14 and the color filter layer 12 in the liquid-crystal cell and comes to run in the normal direction, or even though it is exposed to the influence thereon of fluctuation of the liquid-crystal molecules in the liquid-crystal layer; and accordingly, as compared with a VA-mode liquid-crystal display device having a non-COA-structured liquid-crystal cell, the front CR can be thereby greatly improved. The effect of the invention could not be attained merely by employing the COA structure and expanding the numerical aperture, but can be attained only by employing the COA structure and by making the rear-side retardation region satisfy the above formula (I).

The same as that for the above color filter layer and the array member shall apply to the other members not shown in FIG. 1 (for example, black matrix). Specifically, to the member through which the incident light passes before coming in the liquid-crystal layer, the same as that for the non-COA structured array member in the above Table shall apply; and to the member through which the incident light passes after passing through the liquid-crystal layer, the same as that for the non-COA structured color filter member in the above Table.

As described above, the incident light polarization state dependence of light leakage at the time of black level of display owing to the optical phenomenon in the color filter, the black matrix and the array member all shows the same tendency; however, the contribution of the black matrix is relatively small, and therefore, the position of the black matrix in a COA-structured liquid-crystal display device may be in any site in the liquid-crystal cell therein, but for attaining a high front CR, the black matrix is preferably in the position between the rear-side polarizing element and the liquid-crystal layer.

The rear-side retardation region 20 in FIG. 1 may have a single layer structure or a laminate structure of two or more layers. In an embodiment where the region has a single layer structure, the layer must satisfy the formula (I); and in an embodiment where the region has a laminate structure of two or more layers, the entire laminate as a whole must satisfy the formula (I).

For attaining a higher front CR, the haze of the film to be disposed as the rear-side retardation region 20 in FIG. 1 is preferably at most 0.5, more preferably at most 0.3, even more preferably at most 0.2. In this description, the film haze may be measured as follows: According to JIS K-6714, a film sample having a size of 40 mm×80 mm is prepared, and analyzed with a haze meter (NDH-2000, by Nippon Denshoku Industry) in an environment at 25° C. and 60% RH, thereby measuring the haze of the film.

The front-side retardation region 22 in FIG. 1 may also have a single layer structure or a laminate structure of two or more layers. In case where the front-side retardation region 22 has a retardation capable of contributing toward improving the viewing angle CR, it is favorable since the effect of the invention, or that is, not only the effect of improving the front CR but also the effect of improving the viewing angel CR can be attained. As described above, Δnd(λ) of the liquid-crystal layer of the liquid-crystal cell LC is generally from 280 to 350 nm or so, but the preferred range of the retardation of the front-side retardation region 22, especially Rth thereof varies depending on the retardation of the rear-side retardation region 20 and Δnd(λ) of the liquid-crystal layer. Preferred combinations of the front-side retardation region and the rear-side retardation region relative to Δnd(λ) of the liquid-crystal layer for improving oblique CR are described in various publications, for example, in Japanese Patents 3282986, 3666666 and 3556159, and may be referred to herein. From this viewpoint, preferably, the front-side retardation region 22 satisfies the following formulae (III) and (IV):

30 nm≦Re(590)≦90 nm, (III)

150 nm≦Rth(590)≦300 nm. (IV)

To satisfy the above characteristics, the front-side retardation region 22 may be composed of, for example, one or more biaxial polymer films, or may contain one or more biaxial polymer films. Further, the front-side retardation region 22 may contain one or more monoaxial polymer films.

Δnd(590) of a VA-mode liquid-crystal cell is generally from 280 to 350 nm or so, and this is for increasing as much as possible the transmittance at the time of white level of display. On the other hand, when Δnd(590) is less than 280 nm, the white brightness may decrease slightly along with the reduction in Δnd(590), but since the cell thickness d is small, the liquid-crystal display device can be excellent in rapid responsibility. The characteristic of the invention is that, when the rear-side first retardation region has a low retardation, the light leakage in the front direction is reduced and, as a result, the front CR is elevated, and this applies to liquid-crystal display devices having any Δnd(590).

In one embodiment of the present invention, the rear-side retardation region (20 in FIG. 1) satisfies the following formula (II):

|Re(590)|≦20 nm. (II)

Even when a high-Re retardation film is disposed on the rear side, the device can enjoy the effect of the invention so far as Rth thereof satisfies the above formula (I). On the other hand, when a retardation film having a somewhat high Re is disposed on the rear side, the axial alignment will have to be attained strictly in relation to the optical axis of the other members, for example, in relation to the absorption axis of the rear-side polarizing element. When the rear-side retardation region has a low Re as a whole and when the region satisfies the above formula (II), it is favorable since the axial alignment is easy in incorporating one or more retardation films serving as the rear-side retardation region in a liquid-crystal display device.

Still another advantage of the invention is reduction in “circular unevenness”. “Circular unevenness” is a phenomenon of circular light leakage occurring when a liquid-crystal panel is exposed to a high-temperature/high-humidity atmosphere and made to be at the time of black level of display. Its details are described in JP-A 2007-187841. One reason for the phenomenon is that the liquid-crystal substrate on the backlight side (that is, the rear-side substrate 16 in FIG. 1) is deformed through exposure to a high-temperature/high-humidity atmosphere. In a COA structure, a color filter layer is disposed on the rear-side substrate in addition to the array member thereon, and therefore, the substrate is hardly deformed even exposed to heat and, as a result, circular unevenness can be thereby reduced.

One embodiment of the present invention is a VA-mode liquid-crystal display device in which the rear-side retardation region (20 in FIG. 1) satisfies the following formula (Ia):

|Rth(590)|≦20 nm. (Ia)

As described above, circular unevenness can be reduced in some degree by employing the COA structure. The present inventors' investigations have revealed that the circular unevenness is influenced by the optical characteristics of the rear-side retardation region, and can be reduced more when Rth of the rear-side retardation region is smaller. This embodiment where the rear-side retardation region satisfies the above formula (Ia) additionally obtains the advantage of further reducing circular unevenness in addition to the above effect of the invention.

From the viewpoint of circular unevenness reduction, the thickness of the retardation film disposed in the rear-side retardation region (20 in FIG. 1) is preferably thinner; and concretely, the thickness is preferably from 2 to 100 μm or so, more preferably from 2 to 60 μm or so, even more preferably from 2 to 40 μm or so.

As described above, in case where a VA-mode liquid-crystal cell has Δnd(590) of from 280 to 350 nm or so, its transmittance at the time of white level of display can be high. In the present embodiment where the rear-side retardation region satisfies the above formula (Ia), the front-side retardation region preferably satisfies the following formulae (IIIa) and (IVa) in order to improve also the viewing angle CR of the device:

30 nm≦Re(590)≦90 nm (IIIa)

180 nm≦Rth(590)≦300 nm; (IVa)

and where Δnd(590) of the VA-mode liquid-crystal cell is from 280 to 350 nm or so, the region more preferably satisfies the following formulae (IIIa-1) and (IVa-1):

50 nm≦Re(590)≦75 nm (IIIa-1)

200 nm≦Rth(590)≦300 nm; (IVa-1)

even more preferably, the following formulae (IIIa-2) and (IVa-2):

50 nm≦Re(590)≦75 nm (IIIa-2)

220 nm≦Rth(590)≦270 nm. (IVa-2)

In consideration of the producibility of retardation film, a constitution of using a retardation film with Rth(590)≦230 nm may be preferred in some cases in practical use. In general, for producing a retardation film having a high retardation, stretching treatment at a high draw ratio or increasing the amount of the additive that contributes toward expression of retardation will be necessary. However, in stretching at a high draw ratio, the film may be often broken or cut; and when the amount of the additive is increased, then the additive may bleed out of the film.

From this viewpoint, for improving the viewing angle CR in the present embodiment where the rear-side retardation region satisfies the above formula (Ia), the front-side retardation region preferably satisfies the following formulae (IIIa) and (IVa):

30 nm≦Re(590)≦90 nm (IIIa)

180 nm≦Rth(590)≦300 nm; (IVa)

and where Δnd(590) of the VA-mode liquid-crystal cell is from 280 to 350 nm or so, the region more preferably satisfies the following formulae (IIIa-3) and (IVa-3):

50 nm≦Re(590)≦80 nm (IIIa-3)

180 nm≦Rth(590)≦280 nm; (IVa-3)

even more preferably, the following formulae (IIIa-4) and (IVa-4):

50 nm≦Re(590)≦80 nm (IIIa-4)

180 nm≦Rth(590)≦230 nm. (IVa-4)

Another embodiment of the present invention is a VA-mode liquid-crystal display device where the rear-side retardation region (20 in FIG. 1) satisfies the following formula (Ib):

20 nm≦|Rth(590)|90 nm. (Ib)

In this embodiment where the rear-side retardation region satisfies the formula (Ib), the rear-side retardation region shares in some degree the retardation necessary for improving the viewing angle CR, and therefore without using a retardation film having an excessively high retardation in the front-side retardation region, the viewing angle CR can be improved. This embodiment where the rear-side retardation region satisfies the formula (Ib) exhibits the above-mentioned effect of the invention and has another advantage in that the viewing angle CR can also be improved with good producibility.

In the present embodiment where the rear-side retardation region satisfies the formula (Ib), the front-side retardation region preferably satisfies the following formulae (IIIb) and (IVb) for improving also the viewing angle CR;

30 nm≦Re(590)≦90 nm (IIIb)

150 nm≦Rth(590)≦270 nm; (IVb)

and where Δnd(590) of the VA-mode liquid-crystal cell is from 280 to 350 nm or so, the region more preferably satisfies the following formulae (IIIb-1) and (IVb-1):

50 nm≦Re(590)≦80 nm (IIIb-1)

170 nm≦Rth(590)≦270 nm; (IVb-1)

even more preferably, the following formulae (IIIb-2) and (IVb-2):

50 nm≦Re(590)≦80 nm (IIIb-2)

170 nm≦Rth(590)≦230 nm. (IVb-2)

In case where Δnd(590) of the VA-mode liquid-crystal cell is less than 280 nm, the region more preferably satisfies the following formulae (IIIb-3) and (IVb-3):

60 nm≦Re(590)≦90 nm (IIIb-3)

150 nm≦Rth(590)≦250 nm; (IVb-3)

even more preferably, the following formulae (IIIb-4) and (IVb-4):

60 nm≦Re(590)≦90 nm (IIIb-4)

150 nm≦Rth(590)≦230 nm. (IVb-4)

Again with reference to FIG. 1, “COA” of the COA structure that the liquid-crystal cell LC in FIG. 1 has is an abbreviation of color-filter-on-array; and a structure where a color filter is formed on an active matrix substrate is referred to as a COA structure. At first, the COA structure merely has a color film formed on a TFT substrate; but recently, for the purpose of improving display characteristics, generally employed is a structure where a pixel electrode is formed on the upper side of a color film and the pixel electrode is connected with TFT through a small hole called a contact hole. In the present invention, any structure is employable. In the COA structure, the thickness of the color filter layer is larger than that of an conventional color filter layer (1 to 2 μm or so), and is generally from 2 to 4 μm or so. This is in order to reduce the parasitic capacitance to be generated between the terminal of the electrode pixel and the wiring. The thickness of the color filter layer of the liquid-crystal display device of the invention is also preferably from 2 to 4 μm or so, but not limited thereto. In producing the COA-structured liquid-crystal cell, the pixel electrode on the color filter layer must be patterned, and therefore, the color filter layer is required to have resistance to etchant and remover. For this purpose, a color filter material (color photosensitive material) controlled to be thick in some degree is used, but a two-layered structure composed of a color filter layer formed of an ordinary color filter material and an overcoat layer may be employed. Any of those structures is employable in the invention.

In addition to the above-mentioned Patent References 1 and 2, the COA structure is described also in JP-A 2007-240544 and 2004-163979; and any structure disclosed in these is employable in the present invention.

The color filter that the liquid-crystal display device of the invention is a color filter comprising a plurality of different colors (e.g., three primary colors of light, red, green and blue, and transparent, yellow, cyan, etc.) in the pixel sites of the substrate, like the color filter that an ordinary liquid-crystal display device has. Various methods for its production are known. For example, generally employed is a method of preparing a coloring photosensitive composition (including a colorless composition) referred to as a color resist using a coloring material (organic pigment, dye, carbon black, etc.), applying it onto a substrate to form a layer thereon, and patterning it through photolithography. Various methods are also known for applying the coloring photosensitive composition onto a substrate. For example, in early times, a spin coater method was employed; and from the viewpoint of saving the coating composition, a slit-and-spin coater method has become employed; and at present, a slit coater method is generally employed. In addition, also known are a roll coating method, a bar coating method, a die coating method, etc. Recently, another method has become employed, comprising patterning to form partitioning walls through photolithography followed by forming image colors according to an inkjet system. Apart from these, further known are a method of combining a coloring non-photosensitive composition and a photosensitive positive resist, a printing method, an electrodeposition method, and a film transfer method. The color filter for use in the invention may be produced in any method.

The material for forming the color filter is not also specifically defined. As the coloring material, usable is any of dye, organic pigment, inorganic pigment, etc. Use of dye has been investigated for satisfying the requirement for contrast ratio elevation; and recently, the technique of dispersing organic pigment has been promoted, and broken-down pigment prepared by finely breaking pigment in a salt-milling method, as well as fine pigment particles prepared by a building-up method have become used for contrast ratio elevation. In the invention, any coloring material may be used.

In FIG. 1, all or a part of the rear-side retardation region 20 and the front-side retardation region 22 may function as a protective film for the rear-side polarizing element 24 and the front-side polarizing element 26, respectively. Though not shown in FIG. 1, the rear-side polarizing element 24 may additionally have any functional film such as protective film, antifouling film, antireflection film, antiglare film, antistatic film or the like on the surface thereof facing the backlight 28; and similarly, the front-side polarizing element may additionally have any functional film such as protective film, antifouling film, antireflection film, antiglare film, antistatic film or the like on the panel-side surface thereof.

As described in the above, in a system where one side shares a large retardation for optical compensation, heretofore, the film having a large retardation is generally disposed on the rear side; however, it is considered that, in case where the high-retardation film is disposed on the front side, as in the present invention, the yield of polarizer may increase. The reason is described below.

The high-retardation film requires a step of stretching it at a high draw ratio, and therefore, its width could hardly be broadened, as compared with inexpensive films not requiring many additives in their production, or that is, so-called plane TAC (triacetyl cellulose film having Re of from 0 to 10 nm and Rth of from 30 to 80 nm), or low-retardation films. In ordinary liquid-crystal display devices, a wide liquid-crystal cell is used, and in general, the absorption axis of the front-side polarizing element is disposed in the horizontal direction (in the width direction) while the absorption axis of the rear-side polarizing element is disposed in the vertical direction (in the length direction). Further, in industrial-scale mass-production, the polarizing element and the retardation film are stuck together generally in a roll-to-roll system. Taking the matter into consideration that the polarizer produced according to the method is stuck to the liquid-crystal cell, it is recommended to arrange the high-retardation film on the front side for efficiently using the width direction of the polarizer, or that is, the production yield is increased. In case where a low-retardation film is disposed on the rear side as in the present invention, the film can be readily prepared as a wide film, and it can be combined with a wide polarizing element to further increase the production yield. As a result, the amount of the polarizer to be wasted may be reduced.

This is described with reference to concrete numerical data. In general, the width of a retardation film is 1100 mm, 1300 mm, 1500 mm, 2000 mm or 2500 mm; and the thickness of the film is about 25 μm, 40 μm or 80 μm. The length of the roll of the film is about 2500 m or 4000 m. On the other hand, regarding the panel size of a VA-mode liquid-crystal display device for application to TV, the panel size may be 20 inches, 32 inches, 40 inches, 42 inches, 52 inches or 68 inches. As one example, 42-inch panels most popularly released at present are discussed here. The 42-inch panel (standard 4:3) has a panel width of 853 mm (42-inch wide panel 16:9 has 930 mm), and a panel height of 640 mm (42-inch wide panel has 523 mm). In a conventional ordinary system where a high-retardation film is disposed on the rear side, only one retardation film for panel could be taken from a retardation film having, for example, a width of 1300 mm or 1500 mm in the width direction thereof. However, in the embodiment of the present invention, a high-retardation film is disposed on the front side, and therefore, even a retardation film having a width of, for example, 1300 mm or 1500 mm could be so cut that the height of the thus-cut film piece corresponding to the height of the panel size could be in the width direction of the film, or that is, retardation films for two panels can be taken in the width direction, and the producibility may be doubled. The TV size is increasing year by year, and for example, a 65-inch (standard) TV has a panel width of 991 mm and a panel height of 1321 mm. In conventional ordinary rear-side arrangement in such a wide-view TV, even a wide-sized 2000-mm film could give only one retardation film for one panel in the width direction. Contrary to this, in the front-side arrangement as in the embodiment of the present invention, the film can give retardation films for two panels in the width direction. Further, a 68-inch (wide-view) TV has a panel width of 1505 mm and a panel height of 846 mm, for which about doubled producibility can be expected similarly.

The VA-mode liquid-crystal display device of the invention can be driven in any mode, concretely in any mode of MVA (Multi-Domain Vertical Alignment), PVA (Patterned Vertical Alignment), OP (Optical Alignment) or PSA (Polymer-Sustained Alignment). The details of these modes are described in JP-A 2006-215326, and JP-T 2008-538819. OP (Optical Alignment) or PSA (Polymer-Sustained Alignment) can provide high front contrast ratio. When applied to high-contrast ratio panels, the present invention can further enhance its effect.

In the invention, the front contrast ratio may be further elevated by controlling the angle profile of the incident light from the backlight. Concretely, when a backlight having a higher power of gathering light is used, the absolute value of the front contrast ratio increases, and therefore the increase in the absolute value of the front CR indicated in the invention may be larger. The index of light-gathering power may be represented, for example, by the ratio of the outgoing light intensity on the front) I(0°) to the outgoing light intensity at a polar angle of 45 degrees) I(45°), I(0°)/I(45°); and a backlight having a larger value of the ratio may be said to have a stronger light-gathering power. As the backlight having a high light-gathering power, preferably, a prism film (prism layer) having a light-gathering function is provided between the diffusion film and the liquid-crystal panel. The prism film is to gather the light that has gone out from the light outgoing face of a light guide and has been diffused in a diffusion film, in the effective display area of a liquid-crystal panel at high efficiency. A liquid-crystal display device with an ordinary direct backlight mounted thereon comprises, for example, a color filter sandwiched between a transparent substrate and a polarizer and a liquid-crystal panel having a liquid-crystal layer in the upper part thereof, and comprises a backlight below them. One typical example of the device of the type is Brightness Enhancement Film (BEF), a registered trade name by US 3M. BEF is a film on which unit prisms each having a triangular cross section are periodically aligned in one direction, in which the prisms have a larger size (pitch) than the wavelength of light. BEF gathers off-axis light, and redirect or recycle it to on-axis light toward viewers. Many patent references such as JP-B 1-37801, JP-A 6-102506 and JP-T 10-506500 are known, which disclose use of a brightness enhancement member having a recurring array structure of prisms such as typically BEF in displays.

For enhancing the light-gathering capability, use of a lens array sheet is also desirable. The lens array sheet has a lens face in which plural unit convex lenses are aligned two-dimensionally at a predetermined pitch. Preferred is a lens array sheet in which the other side opposite to the lens face is a flat face, and on the flat face, a light reflection layer to reflect the incident light in the non-light-gathering region of the lens is formed. Also preferred is a lens array sheet having a lenticular lens face with plural convex cylindrical lenses aligned in parallel to each other at a predetermined pitch, and a flat face opposite to the lens face, wherein, on the flat face, a light reflection layer is formed that reflects the stripe-like incident light in the lengthwise direction in the non-light-gathering region of the convex cylindrical lenses. Also usable are, for example, a lenticular lens array sheet having in the face thereof unit lenses each composed of a cylindrical curved face as aligned in one direction, and a lens array sheet having in the face thereof unit lenses each composed of a circular, rectangular or hexagonal bottom and a dome-like curved face as aligned two-dimensionally. These lens array sheets are described in JP-A 10-241434, 2001-201611, 2007-256575, 2006-106197, 2006-208930, 2007-213035 and 2007-41172, of which the contents are incorporated herein by reference.

The present invention exhibits its effect also in an embodiment of a display in which the color reproduction region is broadened by controlling the emission spectrum from the backlight and the transmission spectrum through the color filter. Concretely, a white backlight is preferably used, comprising a color mixing combination of a red LED, a green LED and a blue LED. Also preferably, the half-value width of the emission peak from the red LED, the green LED and the blue LED is small. Regarding LED, the half-value wavelength width thereof is 20 nm or so and is small as compared with that of CCFL, and the white purity of the light source itself may be increased by controlling the peak wavelength of R (red) to at least 610 nm, that of G (green) to 530 nm and that of B (blue) to at most 480 nm.

It is reported that, outside the peak wavelength of LED, the spectral transmission of the color filter is controlled to be as small as possible whereby the color reproducibility is further enhanced, and the NTSC ratio is specifically 100%. For example, it is described in JP-A 2004-78102. The red color filter preferably has a low transmission at the peak position of the green LED and the blue LED; the green color filer preferably has a low transmission at the peak position of the blue LED and the red LED; and the blue color filter preferably has a low transmission at the peak position of the red LED and the green LED. Concretely, the transmission is at most 0.1 in every case, more preferably at most 0.03, even more preferably at most 0.01. The relationship between the backlight and the color filter is described, for example, in JP-A 2009-192661, the content of which may be incorporated herein by reference.

Use of a laser light source for the backlight is also preferred for broadening the color reproduction region. Preferably, the peak wavelength of the red, green and blue laser light sources are from 430 to 480 nm, from 520 to 550 nm, and from 620 to 660 nm, respectively. The backlight of laser light sources is described in JP-A 2009-14892, the content of which may be incorporated herein by reference.

Hereinafter, various members to be used in the VA-mode liquid crystal display device of the invention will be described in detail.

### 1. Rear-Side Retardation Region and Front-Side Retardation Region

According to the invention, one or two or more retardation layers as a whole, which are disposed between the rear-side polarizing element and the VA-type liquid crystal cell, are called “rear-side retardation region”. The rear-side retardation region satisfies the above formula (I) as a whole, and preferably satisfies the above formula (II) as a whole.

According to one embodiment of the invention, the rear-side retardation region satisfies the above formula (Ia), preferably satisfies the following formulas:

0 nm≦Re(590)≦20 nm and |Rth(590)|≦20 nm; more preferably satisfies the following formulas:

0 nm≦Re(590)≦10 nm and |Rth(590)|≦10 nm; and even more preferably satisfies the following formulas:

0 nm≦Re(590)≦5 nm and |Rth(590)|≦5 nm.

According to another embodiment of the invention, the rear-side retardation region satisfies the above formula (Ib), preferably satisfies the following formulas:

0 nm≦Re(590)≦20 nm and 20 nm<|Rth(590)|≦90 nm; more preferably satisfies the following formulas:

0 nm≦Re(590)≦10 nm and 30 nm≦|Rth(590)|≦90 nm; and even more preferably satisfies the following formulas:

0 nm≦Re(590)≦10 nm and 40 nm≦|Rth(590)|≦80 nm.

According to the invention, one or two or more retardation layers as a whole, which are disposed between the front-side polarizing element and the VA-type liquid crystal cell, are called “front-side retardation region”. The front-side retardation region preferably exhibits retardation which is capable of contributing to improvement of viewing angle CR as a whole and in the relationship with the rear-side retardation region.

In particular, the front-side retardation region preferably satisfies the above formulas (III) and (IV); in the embodiment wherein the rear-side retardation region satisfies the above formula (Ia), the front-side retardation region preferably satisfies the above formulas (IIIa) and (IVa); and in the embodiment wherein Δnd(590) is from about 280 nm to about 350 nm, the front-side retardation region more preferably satisfies the above formulas (IIIa-1) and (IVa-2), and even more preferably satisfies the above formulas (IIIa-2) and (IVa-2). In the embodiment wherein Δnd(590) is equal to or smaller than 280 nm, the front-side retardation region more preferably satisfies the above formulas (IIIa-3) and (IVa-3), and even more preferably satisfies the above formulas (IIIa-4) and (IVa-4). And in the embodiment wherein the rear-side retardation region satisfies the above formula (Ib), the front-side retardation region preferably satisfies the above formulas (IIIb) and (IVb); and in the embodiment wherein Δnd(590) is from about 280 nm to about 350 nm, the front-side retardation region more preferably satisfies the above formulas (IIIb-1) and (IVb-2), and even more preferably satisfies the above formulas (IIIb-2) and (IVb-2). In the embodiment wherein Δnd(590) is equal to or smaller than 280 nm, the front-side retardation region more preferably satisfies the above formulas (IIIb-3) and (IVb-3), and even more preferably satisfies the above formulas (IIIb-4) and (IVb-4).

The materials of each layer constituting the rear-side or front-side retardation region are especially not limited. The retardation region satisfying the formulas (I) and (II) or the formulas (III) and (IV) may consist of a single or plural biaxial films or consist of any combination of plural monoaxial films such as A-plate and C-plate. The retardation region may also consist of one or more monoaxial films and one or more biaxial films. In terms of low cost, preferably, either the rear-side or front-side retardation region consists of any single film, and more preferably, both consist of any single film.

In any embodiment mentioned above, retardation in plane, Re, of the rear-side and front-side retardation regions preferably exhibits a higher value at a longer wavelength, that is, the reversed-dispersion characteristics, in the visible light wavelength. That is, satisfying Re(450)<Re(550)<(Re(590)<)Re(650) is preferable. This is because, using the retardation region in which Re exhibits the reversed wavelength dispersion characteristics, the optical properties may be optimized in all of visible-light wavelength region if the optical properties are optimized at the center wavelength of the visible light, about 550 nm. Most preferably, Re of the retardation region exhibits the reversed-dispersion characteristics, and preferably Re of the retardation region is constant with wavelength variation. As well as Re, Rth of the rear-side retardation region preferably exhibits a higher value at a longer wavelength, that is, the reversed-dispersion characteristics, or is preferably constant with wavelength variation in the visible light wavelength. The reversed-dispersion characteristics is more preferable. That Rth exhibits the reversed-dispersion characteristics or is constant is defined identically as Rth satisfying the following two formulas:

|Rth(450)|/|Rth(550)|≦1 and 1≦|Rth(630)|/|Rth(550)|.

The embodiment, wherein Re of the rear-side retardation region exhibits the characteristics other than normal-dispersion characteristics, that is, Re exhibits the reversed-dispersion characteristics or is constant with wavelength variation, is preferable in terms of reducing the front bluish tone in the black state, compared with the embodiment, wherein Re of the rear-side retardation region exhibits the normal-dispersion characteristics.

The effect caused by Re of the rear-side retardation region exhibiting the reversed-dispersion characteristics is improvement in the front black state (reduction in the front bluish tone in the black state); and, on the other hand, the effect caused by Re of the front-side retardation region exhibiting the reversed-dispersion characteristics is improvement in the viewing angle characteristics such as improvement in viewing angle CR and improvement in the viewing angle color (reduction in the color variation in the oblique direction in the black state). Namely, the embodiment, wherein the rear-side retardation region exhibits low retardation and the reversed-dispersion characteristics and the front-side retardation region satisfies the above formulas (II) and (IV) and exhibits the reversed-dispersion characteristics, may be improved in terms of both of front CR and viewing angle CR, that is, may exhibit the good characteristics in terms of the front and viewing angle black state.

For achieving the higher front CR, haze of the retardation film constituting the rear-side or front-side retardation region is preferably equal to or smaller than 0.5, more preferably equal to or smaller than 0.3, and even more preferably equal to or smaller than 0.2.

In the description, the method for measuring haze of a film is as follows. A film sample, 40 mm×80 mm, is prepared, and haze of the sample is measured using a haze-meter (NDH-2000, NIPPON DENSHOKU INDUSTRIES CO., LTD.) under a condition of 25 degrees Celsius and 60% RH according to JIS K-6714.

The rear-side or front-side retardation region may be formed of a retardation film alone or formed of a lamination of two or more films. And the materials thereof are not limited as far as it satisfies the above-described properties. For example, one or two or polymers may be selected from the group consisting of a cellulose acylate, a polycarbonate-based polymer, a polyester-based polymer such as polyethylene terephthalate or polyethylene naphthalate, an acrylic-based polymer such as polymethylmethacrylate, or a styrene-based polymer such as polystyrene or an acrylonitrile-styrene copolymer (AS resin) may be used. Polyolefin such as polyethylene or polypropylene, a polyolefin-based polymer such as an ethylene-propylene copolymer, a vinyl chloride-based polymer, an amide-based polymer such as nylon or aromatic polyamide, an imido-based polymer, a sulfone-based polymer, a polyether sulfone-based polymer, polyetherether ketone-based polymer, a polyphenylensulfide-based polymer, a vinylidene chloride-based polymer, a vinyl alcohol-based polymer, a vinyl butyral-based polymer, an acrylate-based polymer, a polyoxymethylene-based polymer, an epoxy-based polymer, and a polymer containing a mixture of the above polymers, and are used as a major ingredient for preparing the retardation film constituting the rear-side or front-side retardation region satisfying the above-described properties.

As a retardation film satisfying the formulas (I) and (II) alone or a lamination of two or more films satisfying the formulas (I) and (II) as a whole, or a retardation film satisfying the formulas (II) and (IV), cellulose acylate-based, acryl-based polymer and cycloolefin-based polymer films are preferable.

### Cellulose Acylate-Based Film:

In the description, the term “cellulose acylate-based film” means a film containing any cellulose acylate(s) as a major ingredient (50 mass % or more with respect to the total mass of all ingredients). The cellulose acylate(s) which can be used for preparing the film is a compound in which hydrogen atom(s) of hydroxy group in the cellulose acylate is substituted with an acyl group. The cellulose acylate is a compound in which hydrogen atom(s) of hydroxy group in the cellulose acylate is substituted with an acyl group; and the acyl group having from 2 (acetyl) to 22 carbon atoms may be used as the substituent. Regarding the cellulose acylate which can be used in the invention, the substitution degree of hydroxy group in cellulose is especially not limited. The degree of substitution (degree of acylation) can be obtained by measuring the binding degree of acetic acid and/or C₃-C₂₂ aliphatic acid to hydroxy(s) in cellulose and then calculating the measured values(s). The measuring may be carried out according to ASTM [symbol] D-817-91.

The substitution degree of the cellulose acylate which can be used as a material of the retardation film(s) constituting the retardation region is especially not limited, and is preferably from 2.30 to 3.00. The reversed-dispersion characteristics of the cellulose acylate-based film may be prepared by controlling the substitution degree or using any retardation enhancer, which is described in JP-A 2009-63983 or the like.

The cellulose acylate is preferably cellulose acetate, and may have any acyl group other than acetyl in place of acetyl or together with acetyl. Among these, cellulose acylates having at least one acyl selected from the group consisting of acetyl, propionyl and butyryl is preferable; and cellulose acylates having at least two selected from the group consisting of acetyl, propionyl and butyryl is more preferable. And cellulose acylates having acetyl and propionyl and/or butyryl are even more preferable; and the cellulose acylates having the substitution degree of acetyl of from 1.0 to 2.97 and the substitution degree of propionyl and/or butyryl of from 0.2 to 2.5 are even much more preferable.

The mass-averaged polymerization degree of the cellulose acylate to be used for preparing the retardation film constituting the retardation region is preferably from 200 to 800, and more preferably from 250 to 550. The number-averaged molecular weight of the cellulose acylate to be used for preparing the retardation film constituting the retardation region is preferably from 70000 to 230000, more preferably from 75000 to 230000, and even more preferably from 78000 to 120000.

Examples of the cellulose acylate(s) which can be used for preparing the film satisfying the formula (Ia) include those described in JP-A 2006-184640, [0019]-[0025].

The cellulose acylate-based film to be used as a part of the retardation region or as the retardation region itself is preferably prepared according to a solution casting method. In this method, a solution (dope) which is prepared by dissolving cellulose acylate in an organic solvent is used for forming the film. When at least one additive is used, the additive may be added to a dope in any step during preparing the dope.

In preparing the cellulose acylate-based film for the front-side retardation region, any retardation enhancer is preferably used, and in preparing the cellulose acylate-based film for the rear-side retardation region, any retardation enhancer may be used. Examples of the retardation enhancer which can be used in the invention include rod-like or discotic compounds and positive-birefringence compounds. Examples of the rod-like or discotic compound include compounds having at least two aromatic rings, and are preferably used as a retardation enhancer. The amount of the rod-like compound is preferably from 0.1 to 30 parts by mass, and more preferably from 0.5 to 20 parts by mass with respect to 100 parts by mass of the polymer ingredients including cellulose acylate. The amount of the discotic compound is preferably from 0.05 to 20 parts by mass, more preferably from 0.1 to 15 parts by mass, and much more preferably from 0.1 to 10 parts by mass with respect to 100 parts by mass of the cellulose acylate.

The discotic compound is more excellent than the rod-like compound in terms of enhancing Rth retardation; and when especially high Rth retardation is required, the discotic compound is preferably used. Plural types of the compounds may be used as a retardation enhancer.

The retardation enhancer preferably has a maximum absorption within the wavelength range of from 250 to 400 nm, and preferably has no absorption within the visible-light range substantially.

Examples of the retardation enhancer include compound (1)-(3) as follows.

### (1) Discotic Compound

The discotic compound is described in detail. As the discotic compound, compounds having at least two aromatic rings may be used.

In the description, the term “aromatic ring” means not only an aromatic hydrocarbon ring but also an aromatic hetero ring. Examples of the discotic compound which can be used in the invention include those described in JP-A 2008-181105, [0038]-[0046].

Examples of the discotic compound which can be used as a material of the retardation film constituting the retardation region include the compounds represented by formula (I) below.

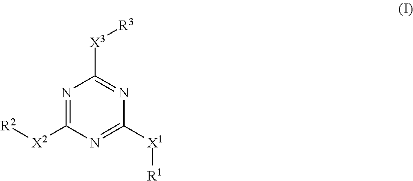

In the formula, X¹ represents a single bond, —NR⁴—, —O— or —S—; X² represents a single bond, —NR⁵—, —O— or —S—; X³ represents a single bond, —NR⁶—, —O— or —S—. And, R¹, R², and R³ independently represent an alkyl group, an alkenyl group, an aromatic ring group or a hetero-ring residue; R⁴, R⁵ and R⁶ independently represent a hydrogen atom, an alkyl group, an alkenyl group, an aryl group or a hetero-ring group.

Preferred examples, I-(1) to IV-(10), of the compound represented by formula (I) include, but are not limited to, those shown below.

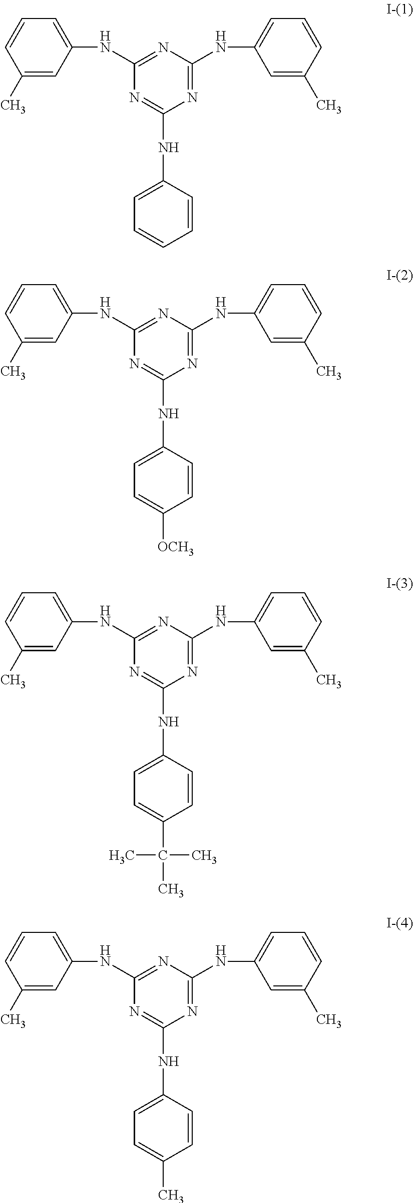

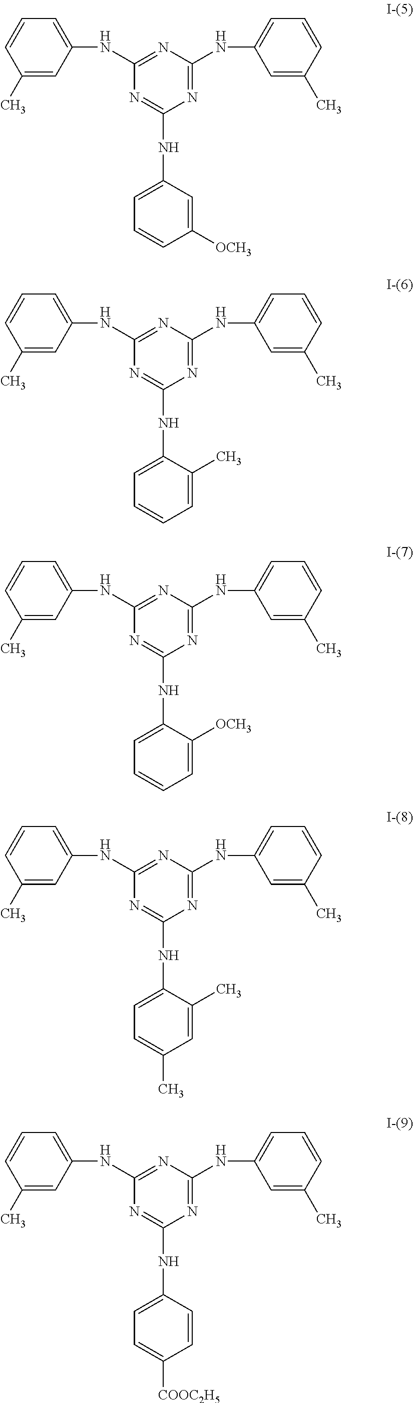

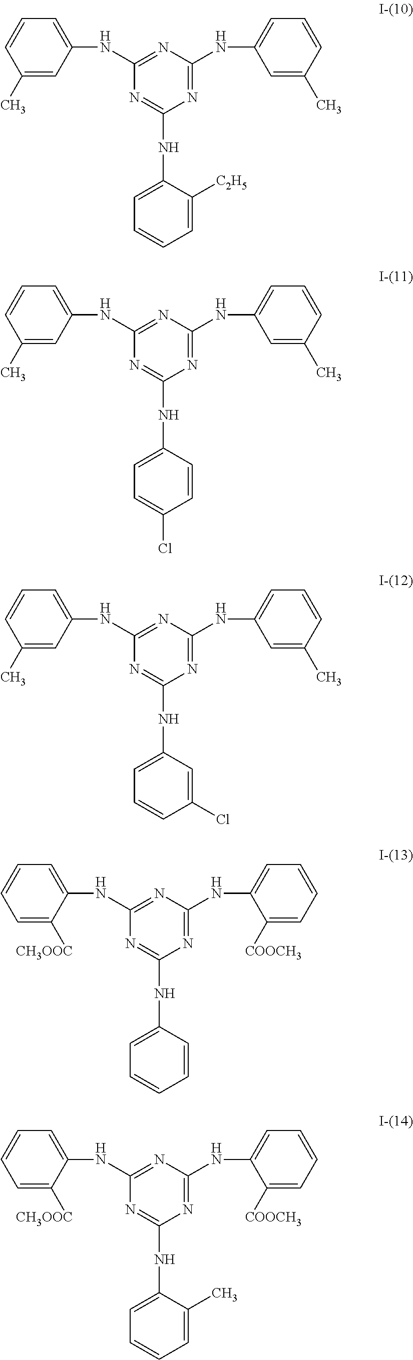

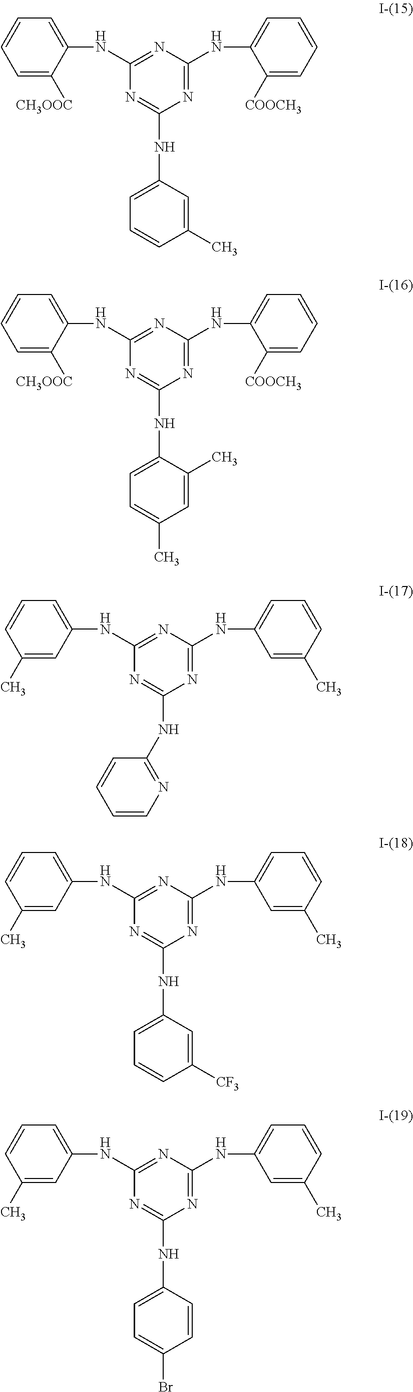

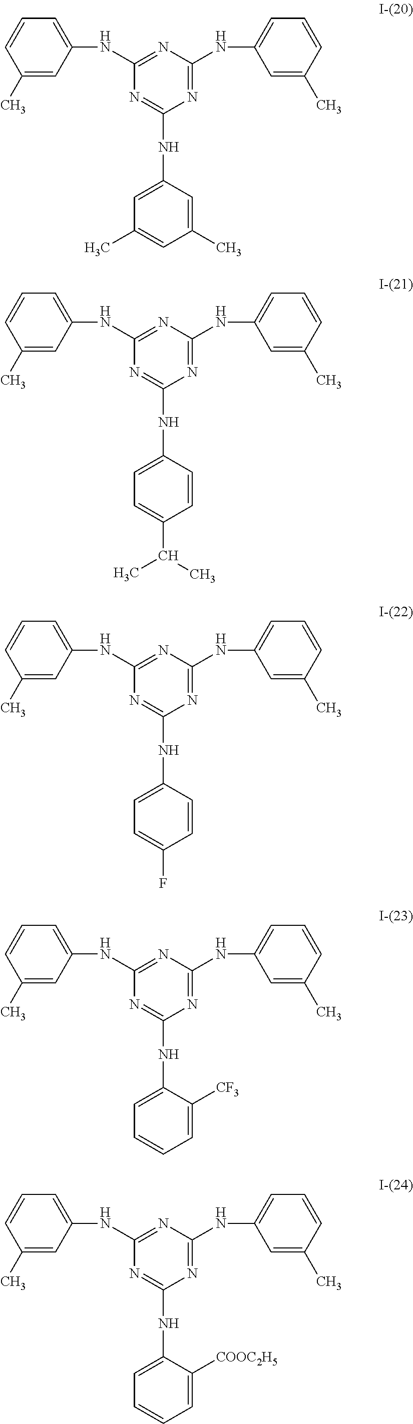

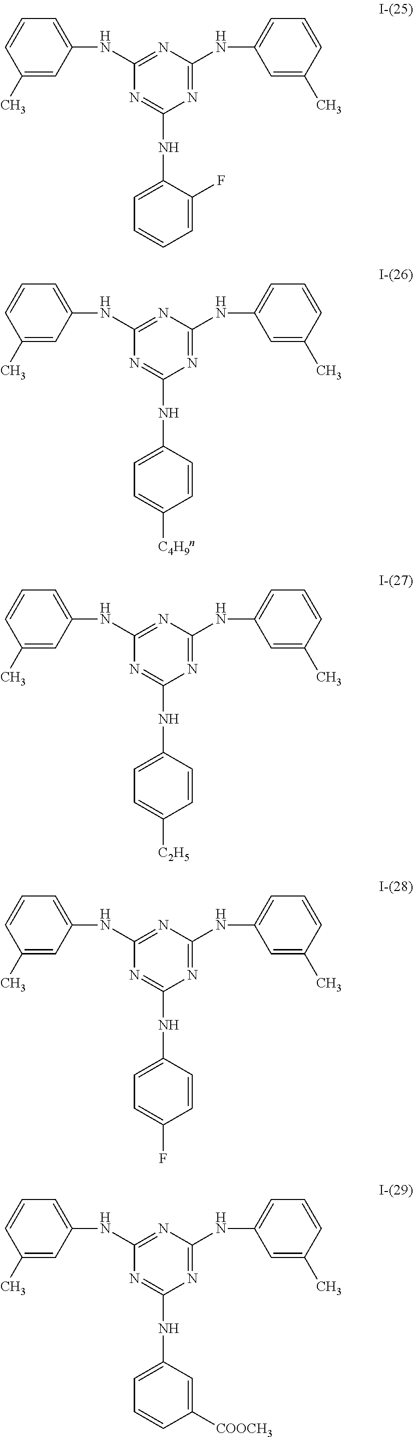

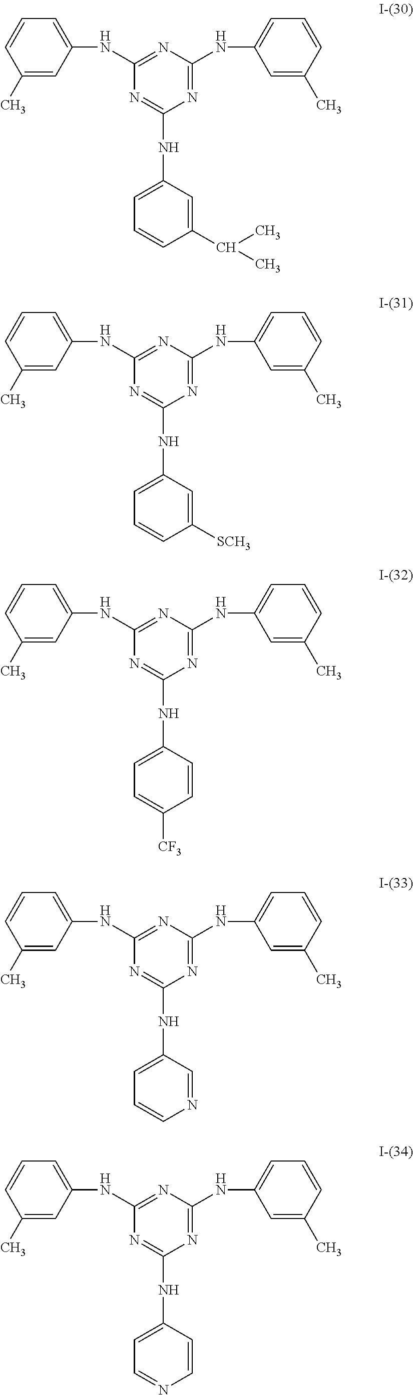

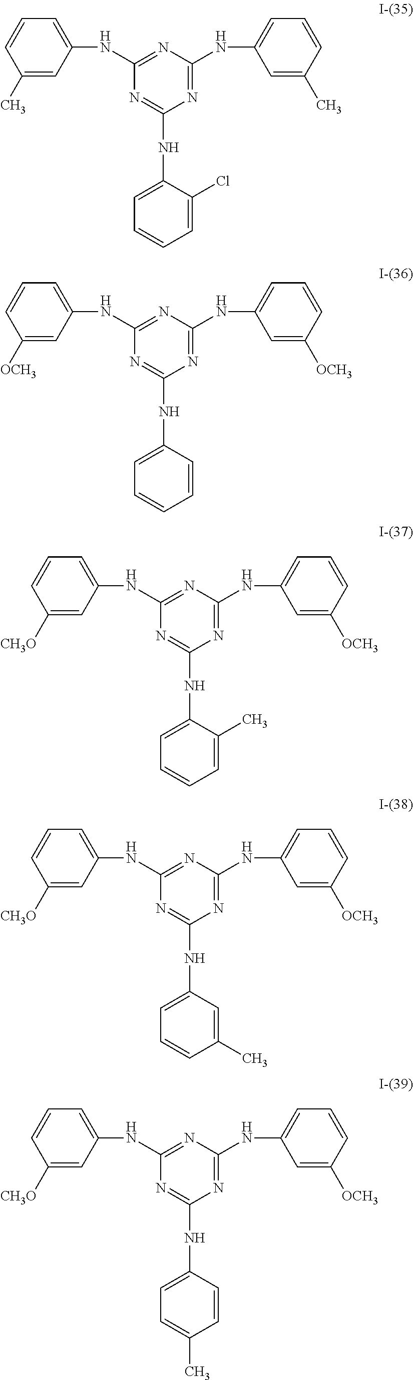

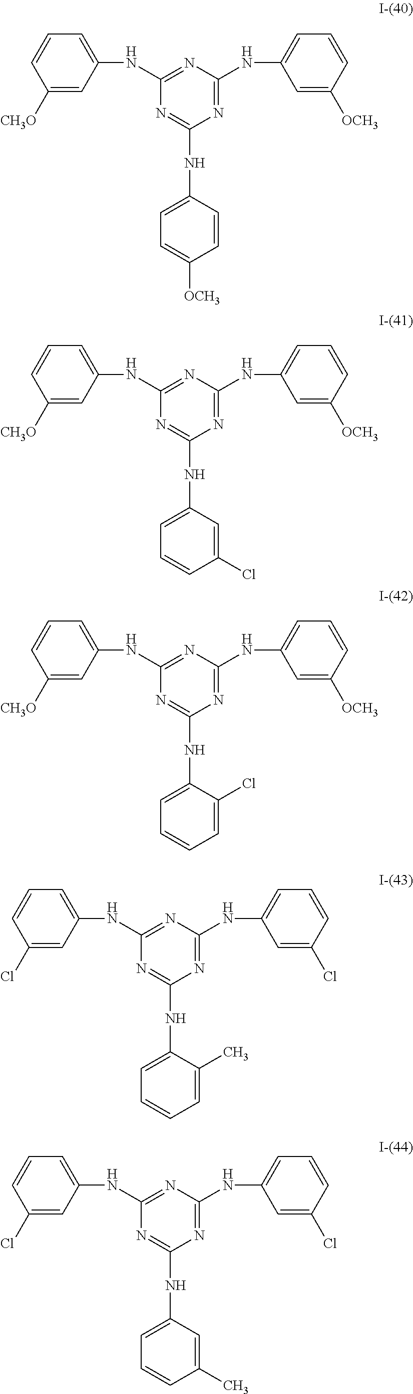

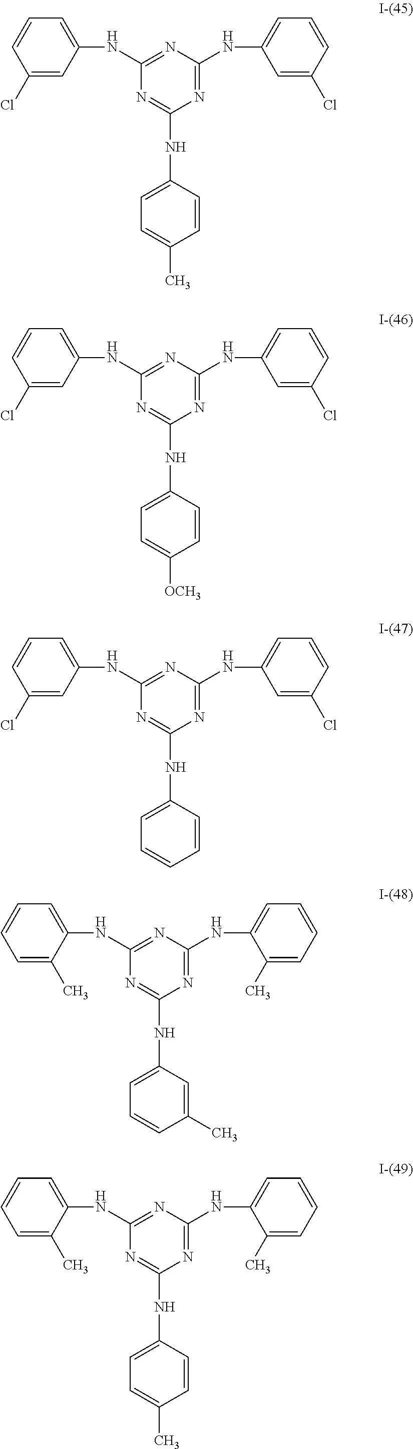

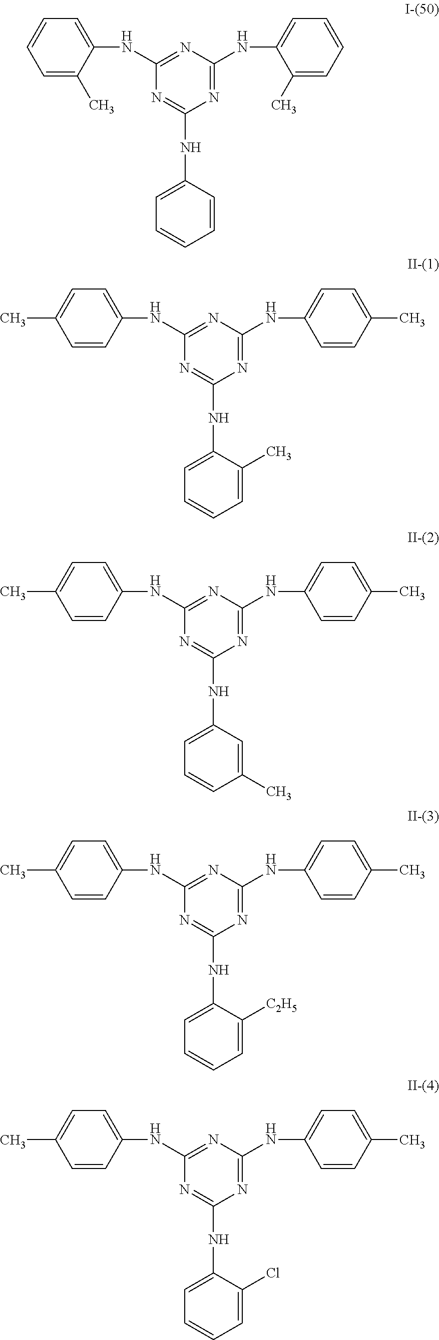

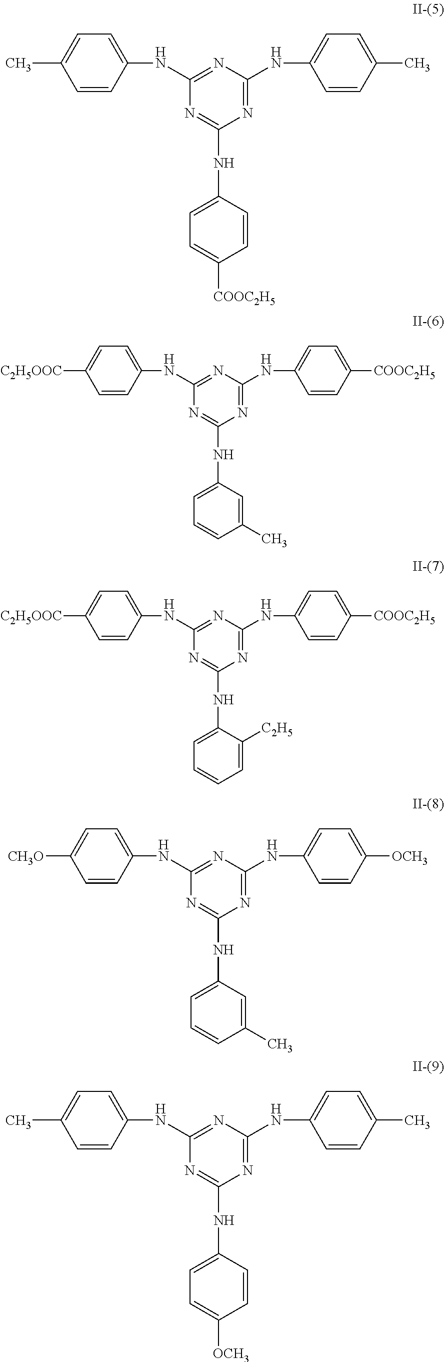

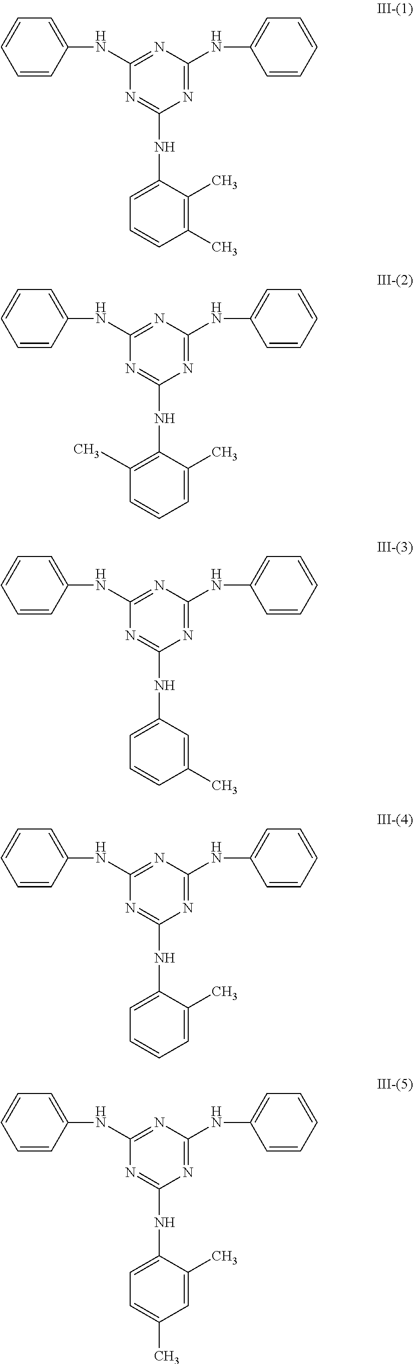

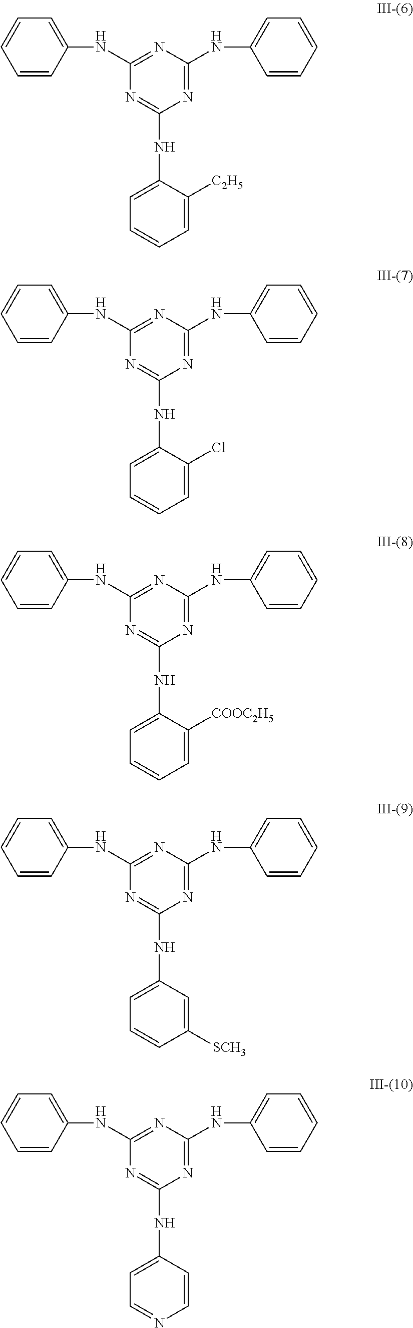

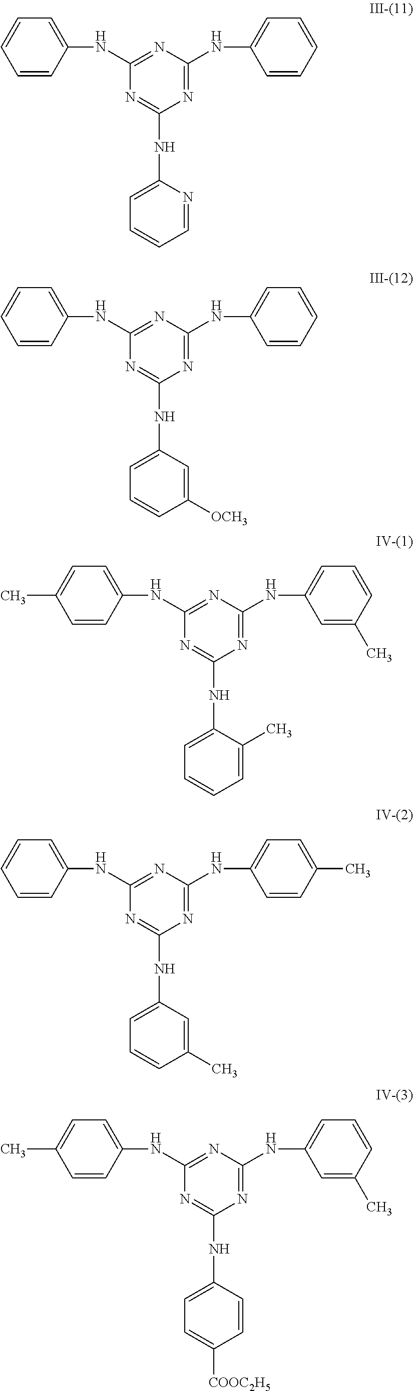

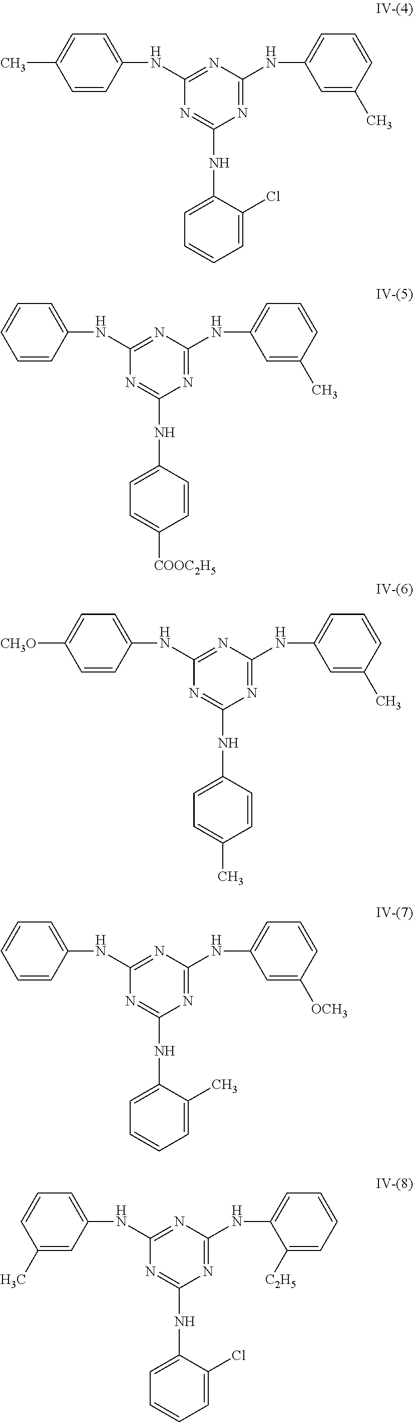

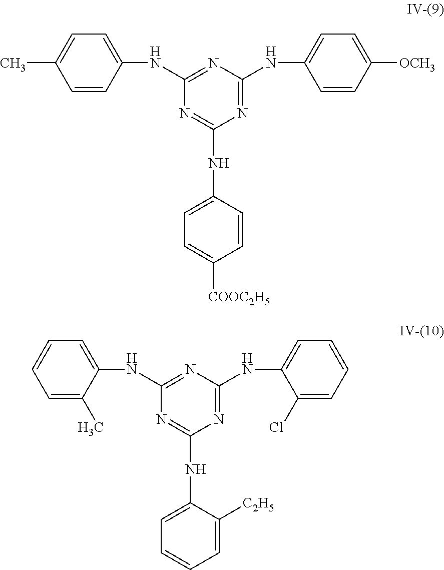

### 2) Rod-Like Compound

In the invention, the rod-like compound, that is, the compound having a straight line-like molecular structure is preferably used other than the discotic compound. Examples of the rod-like compound which can be used in the invention include those described in JP-A 2007-268898, [0053]-[0095].

### (3) Positive-Birefringent Compound

A positive-birefringent compound is a polymer as follows: a layer formed of monoaxially oriented molecules of a polymer exhibits a larger refractive index relative to the light coming along the orientation direction and a smaller refractive index relative to the light coming along the perpendicular direction to the orientation direction, and in such a case, the polymer is a positive-birefringent polymer.

Such a positive-birefringent compound is not limited, and examples of the positive-birefringent compound include polymers having intrinsic positive birefringence such as polyamides, polyimides, polyesters, polyetherletones, polyamideimides and polyesterimides; polyetherketones and polyester-based polymers are preferable; and polyester-based polymers are more preferable.

The polyester-based polymers are prepared by carrying out the reaction of the mixture of C₂₋₂₀ aliphatic dicarboxylic acids and C₈₋₂₀ aromatic dicarboxylic acids with at least one diol selected from C₂₋₁₂ aliphatic diols, C₄₋₂₀ alkylether diols and C₆₋₂₀ aromatic diols. If necessary, the both terminals of the products may be blocked by carrying out the reaction with mono carboxylic acid, mono alcohol or phenol. Blocking the terminal may be carried out for avoiding contamination of any free carboxylic acid, and is preferable in terms of preservation stability. The dicarboxylic acids which can be used for preparing the polyester-based polymers are preferably C₄₋₂₀ aliphatic dicarboxylic acids or C₈₋₂₀ aromatic dicarboxylic acids.

Examples of the preferable C₂₋₂₀ aliphatic dicarboxylic acids which can be used preferable include oxalic acid, malonic acid, succinic acid, maleic acid, fumaric acid, glutaric acid, adipic acid, pimelic acid, suberic acid, azelaic acid, sebacic acid, dodecanedicarboxylic acid and 1,4-cyclohexane dicarboxylic acid.

Examples of C₈₋₂₀ aromatic dicarboxylic acid include phthalic acid, terephthalic acid, isophthalic acid, 1,5-naphtharene dicarboxylic acid, 1,4-naphtharene dicarboxylic acid, 1,8-naphtharene dicarboxylic acid, 2,8-naphtharene dicarboxylic acid and 2,6-naphtharene dicarboxylic acid.

Among these aliphatic dicarboxylic acids, malonic acid, succinic acid, maleic acid, fumaric acid, glutaric acid, adipic acid, azelaic acid and 1,4-cyclohexane dicarboxylic acid are preferable; and among these aromatic dicarboxylic acids, phthalic acid, terephthalic acid, isophthalic acid, 1,5-naphtharene dicarboxylic acid and 1,4-naphtharene dicarboxylic acid are preferable. Among these aliphatic dicarboxylic acids, succinic acid, glutaric acid and adipic acid are especially preferable; and among these aromatic dicarboxylic acids, phthalic acid, terephthalic acid and isophthalic acid are especially preferable.

Any combination of the above-described aliphatic dicarboxylic acid and aromatic dicarboxylic acid may be used, and the combination is not especially limited. Plural types of them may be combined respectively.

The diol or aromatic diol which can be used in the positive birefringent compound may be, for example, selected from C₂₋₂₀ aliphatic diols, C₄₋₂₀ alkylether diols and C₆₋₂₀ aromatic diols

Examples of C₂₋₂₀ aliphatic diol include alkyl diols and alicyclic diols such as ethane diol, 1,2-propanediol, 1,3-propanediol, 1,2-butanediol, 1,3-butanediol, 2-methyl-1,3-propanediol, 1,4-butanediol, 1,5-pentanediol, 2,2-dimethyl-1,3-propanediol (neopentyl glycol), 2,2-diethyl-1,3-propanediol (3,3-dimethyrol pentane), 2-n-butyl-2-ethyl-1,3-propanediol (3,3-dimethyrol heptane), 3-methyl-1,5-pentanediol, 1,6-hexanediol, 2,2,4-trimethyl-1,3-pentanediol, 2-ethyl-1,3-hexanediol, 2-methyl-1,8-octanediol, 1,9-nonanediol, 1,10-decanediol, and 1,12-octadecanediol. These glycols may be used alone or in combination with other(s).

Ethane diol, 1,2-propanediol, 1,3-propanediol, 1,2-butanediol, 1,3-butanediol, 2-methyl-1,3-propanediol, 1,4-butanediol, 1,5-pentanediol, 3-methyl-1,5-pentanediol, 1,6-hexanediol, 1,4-cyclohexane diol and 1,4-cyclohexane dimethanol are preferable; and ethane diol, 1,2-propanediol, 1,3-propanediol, 1,2-butanediol, 1,3-butanediol, 1,4-butanediol, 1,5-pentanediol, 1,6-hexanediol, 1,4-cyclohexane diol and 1,4-cyclohexane dimethanol are especially preferable.

Preferable examples of C₄₋₂₀ alkylether diol include polytetramethylene ether glycol, polyethylene ether glycol, polypropylene ether glycol and any combinations thereof. The averaged polymerization degree is especially not limited, and preferably from 2 to 20, more preferably from 2 to 10, much more preferably from 2 to 5 and especially preferably from 2 to 4. Examples of such a compound include useful commercially-available polyether glycols such as Carbowax resins, Pluronics resins and Niax resins.

Examples of C₆₋₂₀ aromatic diol include, however are not limited, bisphenol A, 1,2-hydroxy benzene, 1,3-hydroxy benzene, 1,4-hydroxy benzene and 1,4-benzene dimethanol. Bisphenol A, 1,4-hydroxy benzene and 1,4-benzene dimethonal are preferable.

The positive birefringent compound is preferably the compound of which terminals are blocked by any alkyl or aryl group. Protecting the terminals with any hydrophobic group is effective for preventing time degradation under a condition of a high temperature and a high humidity, and this is because it may play a role of prolonging hydrolysis of ester groups.

For avoiding terminal OH or carboxylic acid in the positive birefringent compound, the terminal is preferably blocked with a monoalcohol residue or a monocarboxylic acid residue.

As the monoalcohol, C₁₋₃₀ substituted or non-substituted monoalcohols are preferable, and examples thereof include aliphatic alcohols such as methanol, ethanol, propanol, isopropanol, butanol, isobutanol, pentanol, isopentanol, hexanol, isohexanol, cyclohexyl alcohol, octanol, isooctanol, 2-ethylhexyl alcohol, nonyl alcohol, isononyl alcohol, tert-nonyl alcohol, decanol, dodecanol, dodeca hexanol, dodeca octanol, allyl alcohol and oleyl alcohol; and substituted alcohols such as benzyl alcohol and 3-phenyl propanol.

Preferable examples of the alcohol which can be used for blocking the terminals include methanol ethanol, propanol, isopropanol, butanol, isobutanol, pentanol, isopentanol, hexanol, isohexanol, cyclohexyl alcohol, isooctanol, 2-ethylhexyl alcohol, isononyl alcohol, oleyl alcohol and benzyl alcohol: and much more preferable examples thereof include methanol ethanol, propanol, isobutanol, cyclohexyl alcohol, 2-ethylhexyl alcohol, isononyl alcohol and benzyl alcohol.

When a monocarboxylic acid residue is used for blocking the terminals, monocarboxylic acid, which is used as a monocarboxylic acid residue, is preferably C₁₋₃₀ substituted or non-substituted monocarboxylic acid. It may be an aliphatic monocarboxylic acid or aromatic monocarboxylic acid. Preferable examples of the aliphatic monocarboxylic acid include acetic acid, propionic acid, butane acid, caprylic acid, caproic acid, decane acid, dodecane acid, stearic acid and oleic acid; and preferable examples of the aromatic monocarboxylic acid include benzoic acid, p-tert-butyl benzoic acid, p-tert-amyl benzoic acid, orthotoluic acid, methatoluic acid, paratoluic acid, dimethyl benzoic acid, ethyl benzoic acid, n-propyl benzoic acid, amino benzoic acid and acetoxy benzoic acid. These compounds may be used alone or in combination with other(s).

The positive birefringent compound can be produced with ease according to any conventional method, for example, according to a polyesterification, interesterification or thermal-fusing condensation method of a dicarboxylic acid component and a diol component and/or a monocarboxylic acid or monoalcohol for blocking terminals, or an interfacial condensation method of an acid chloride of a dicarboxylic acid component and a glycol. Polycondensate esters usable in the invention are described in detail in Koichi Murai, “Plasticizers and their Theory and Applications” (by Miyuki Shobo, 1st Ed., issued on Mar. 1, 1973). In addition, also usable herein are materials described JP-A Nos. 5-155809, 5-155810, 5-197073, 2006-259494, 7-330670, 2006-342227, and 2007-3679.

Examples of the positive birefringent compound include, however are not limited to, those shown below.

TABLE 2

| | Dicarboxylic acid | | | Diol | | |
|---|---|---|---|---|---|---|
| | | | Ratio of | | | Number- |
| | Aromatic | Aliphatic | dicarboxylic | | | averaged |
| | dicarboxylic | dicarboxylic | acids | | | molecular |
| | acid | acid | (mol %) | Aliphatic diol | Both terminals | weight |
| P-1 | — | AA | 100 | Ethane diol | hydroxyl | 1000 |
| P-2 | — | AA | 100 | Ethane diol | hydroxyl | 2000 |
| P-3 | — | AA | 100 | Propane diol | hydroxyl | 2000 |
| P-4 | — | AA | 100 | Butane diol | hydroxyl | 2000 |
| P-5 | — | AA | 100 | Hexane diol | hydroxyl | 2000 |
| P-6 | — | AA/SA | 60/40 | Ethane diol | hydroxyl | 900 |
| P-7 | — | AA/SA | 60/40 | Ethane diol | hydroxyl | 1500 |
| P-8 | — | AA/SA | 60/40 | Ethane diol | hydroxyl | 1800 |
| P-9 | — | SA | 100 | Ethane diol | hydroxyl | 1500 |
| P-10 | — | SA | 100 | Ethane diol | hydroxyl | 2300 |
| P-11 | — | SA | 100 | Ethane diol | hydroxyl | 6000 |
| P-12 | — | SA | 100 | Ethane diol | hydroxyl | 1000 |
| P-13 | PA | SA | 50/50 | Ethane diol | hydroxyl | 1000 |
| P-14 | PA | SA | 50/50 | Ethane diol | hydroxyl | 1800 |
| P-15 | PA | AA | 50/50 | Ethane diol | hydroxyl | 2300 |
| P16 | PA | SA/AA | 40/30/30 | Ethane diol | hydroxyl | 1000 |
| P-17 | PA | SA/AA | 50/20/30 | Ethane diol | hydroxyl | 1500 |
| P-18 | PA | SA/AA | 50/30/20 | Ethane diol | hydroxyl | 2600 |
| P-19 | TPA | SA | 50/50 | Ethane diol | hydroxyl | 1000 |
| P-20 | TPA | SA | 50/50 | Ethane diol | hydroxyl | 1200 |
| P-21 | TPA | AA | 50/50 | Ethane diol | hydroxyl | 2100 |
| P-22 | TPA | SA/AA | 40/30/30 | Ethane diol | hydroxyl | 1000 |
| P-23 | TPA | SA/AA | 50/20/30 | Ethane diol | hydroxyl | 1500 |
| P-24 | TPA | SA/AA | 50/30/20 | Ethane diol | hydroxyl | 2100 |
| P-25 | PA/TPA | AA | 15/35/50 | Ethane diol | hydroxyl | 1000 |
| P-26 | PA/TPA | AA | 20/30/50 | Ethane diol | hydroxyl | 1000 |
| P-27 | PA/TPA | SA/AA | 15/35/20/30 | Ethane diol | hydroxyl | 1000 |
| P-28 | PA/TPA | SA/AA | 20/30/20/30 | Ethane diol | hydroxyl | 1000 |
| P-29 | PA/TPA | SA/AA | 10/50/30/10 | Ethane diol | hydroxyl | 1000 |
| P-30 | PA/TPA | SA/AA | 5/45/30/20 | Ethane diol | hydroxyl | 1000 |
| P-31 | — | AA | 100 | Ethane diol | acetyl ester residue | 1000 |
| P-32 | — | AA | 100 | Ethane diol | acetyl ester residue | 2000 |
| P-33 | — | AA | 100 | Propane diol | acetyl ester residue | 2000 |
| P-34 | — | AA | 100 | Butane diol | acetyl ester residue | 2000 |
| P-35 | — | AA | 100 | Hexane diol | acetyl ester residue | 2000 |
| P-36 | — | AA/SA | 60/40 | Ethane diol | acetyl ester residue | 900 |

TABLE 3

| | Dicarboxylic acid | | | Diol | | |
|---|---|---|---|---|---|---|
| | | | Ratio of | | | Number- |
| | Aromatic | Aliphatic | dicarboxylic | | | averaged |
| | dicarboxylic | dicarboxylic | acids | | | molecular |
| | acid | acid | (mol %) | Aliphatic diol | Both terminals | weight |
| P-37 | — | AA/SA | 60/40 | Ethane diol | acetyl ester residue | 1000 |
| P-38 | — | AA/SA | 60/40 | Ethane diol | acetyl ester residue | 2000 |
| P-39 | | SA | 100 | Ethane diol | acetyl ester residue | 1000 |
| P-40 | — | SA | 100 | Ethane diol | acetyl ester residue | 3000 |
| P-41 | — | SA | 100 | Ethane diol | acetyl ester residue | 5500 |
| P42 | — | SA | 100 | Ethane diol | acetyl ester residue | 1000 |
| P-43 | PA | SA | 50/50 | Ethane diol | acetyl ester residue | 1000 |
| P-44 | PA | SA | 50/50 | Ethane diol | acetyl ester residue | 1500 |
| P-45 | PA | AA | 50/50 | Ethane diol | acetyl ester residue | 2000 |
| P-46 | PA | SA/AA | 40/30/30 | Ethane diol | acetyl ester residue | 1000 |
| P-47 | PA | SA/AA | 33/33/34 | Ethane diol | benzoic acid | 1000 |
| P-48 | PA | SA/AA | 50/20/30 | Ethane diol | acetyl ester residue | 1500 |
| P-49 | PA | SA/AA | 50/30/20 | Ethane diol | acetyl ester residue | 2000 |
| P-50 | TPA | SA | 50/50 | Ethane diol | acetyl ester residue | 1000 |
| P-51 | TPA | SA | 50/50 | Ethane diol | acetyl ester residue | 1500 |
| P-52 | TPA | SA | 45/55 | Ethane diol | acetyl ester residue | 1000 |
| P-53 | TPA | AA | 50/50 | Ethane diol | acetyl ester residue | 2200 |
| P-54 | TPA | SA | 35/65 | Ethane diol | acetyl ester residue | 1000 |
| P-55 | TPA | SA/AA | 40/30/30 | Ethane diol | acetyl ester residue | 1000 |
| P-56 | TPA | SA/AA | 50/20/30 | Ethane diol | acetyl ester residue | 1500 |
| P-57 | TPA | SA/AA | 50/30/20 | Ethane diol | acetyl ester residue | 2000 |
| P-58 | TPA | SA/AA | 20/20/60 | Ethane diol | acetyl ester residue | 1000 |
| P-59 | PA/TPA | AA | 15/35/50 | Ethane diol | acetyl ester residue | 1000 |
| P-60 | PA/TPA | AA | 25/25/50 | Ethane diol | acetyl ester residue | 1000 |
| P-61 | PA/TPA | SA/AA | 15/35/20/30 | Ethane diol | acetyl ester residue | 1000 |
| P-62 | PA/TPA | SA/AA | 20/30/20/30 | Ethane diol | acetyl ester residue | 1000 |
| P-63 | PA/TPA | SA/AA | 10/50/30/10 | Ethane diol | acetyl ester residue | 1000 |
| P-64 | PA/TPA | SA/AA | 5/45/30/20 | Ethane diol | acetyl ester residue | 1000 |
| P-65 | PA/TPA | SA/AA | 5/45/20/30 | Ethane diol | acetyl ester residue | 1000 |
| P-66 | IPA | AA/SA | 20/40/40 | Ethane diol | acetyl ester residue | 1000 |
| P-67 | 2,6-NPA | AA/SA | 20/40/40 | Ethane diol | acetyl ester residue | 1200 |
| P-68 | 1,5-NPA | AA/SA | 20/40/40 | Ethane diol | acetyl ester residue | 1200 |
| P-69 | 1,4-NPA | AA/SA | 20/40/40 | Ethane diol | acetyl ester residue | 1200 |
| P-70 | 1,8-NPA | AA/SA | 20/40/40 | Ethane diol | acetyl ester residue | 1200 |
| P-71 | 2,8-NPA | AA/SA | 20/40/40 | Ethane diol | acetyl ester residue | 1200 |

In Tables 2 and 3, PA means phthalic acid; TPA means terephthalic acid; IPA means isophthalic acid; AA means adipic acid; SA means succinic acid; 2,6-NPA means 2,6-naphthalene dicarboxylic acid; 2,8-NPA means 2,8-naphthalene dicarboxylic acid; 1,5-NPA means 1,5-naphthalene dicarboxylic acid; 1,4-NPA means 1,4-naphthalene dicarboxylic acid; and 1,8-NPA means 1,8-naphthalene dicarboxylic acid.

The amount of such the positive birefringent compound is preferably from 1 to 30 parts by mass, more preferably from 4 to 25 parts by mass and much more preferably from 10 to 20 parts by mass with respect to 100 part by mass of the cellulose acylate.

The cellulose acylate solution to be used for preparing the cellulose acylate-based film may be added with any additive other than the retardation enhancer. Examples of another additive include antioxidants, UV inhibitors, peeling promoters, plasticizers, agents for controlling wavelength-dispersion, fine particles and agents for controlling optical properties. They may be selected from any known additives.

The cellulose acylate solution for the rear-side or front-side retardation region may be added with any plasticizer in order to improve the mechanical properties of the prepared film or the drying rate. Examples of the plasticizer which can be used in the invention include those described in JP-A 2008-181105, [0067].

For preparing the cellulose acylate-based film satisfying the formula (Ia), one or more additives described in JP-A 2006-184640, [0026]-[0218] may be used. The preferred range of the additive is as same as that described in the publication.

### Acryl-Based Polymer Film:

The acryl-based polymer film which can be used in the invention is a film containing an acryl-based polymer having at least one repeating unit of (meth)acrylic acid ester as a major ingredient. Preferable examples of the acryl-based polymer include acryl-based polymers having at least one unit selected from the group consisting of lactone ring unit, maleic acid anhydride unit and glutaric anhydride together with at least one repeating unit of (meth)acrylic acid ester. Such acryl-based polymers are described in detail in JP-A 2008-9378, to which can be referred.

As another polymer, cellulose-based polymer is preferably added to the acryl-based polymer film; and in such an embodiment, they may be act in a complementary system, and the mixed materials may have any desired properties. The amount of the cellulose-based polymer is preferably from about 5 to about 40% by mass with respect to the total mass of all polymers. Usually, an acryl-based polymer film has a low moisture-permeability, and therefore, residual water is hardly to be removed after producing a polarizing plate. On the other hand the acryl-based polymer film containing cellulose-based polymer may have an appropriate moisture-permeability. Examples of such the acryl-based polymer film include the film containing cellulose acylate by the amount of 10% by mass, described in Table 4 hereinafter, and films containing cellulose acylate propionate (“CAP482-20” manufactured by Eastman Chemical) by the amount of 30% by mass.

### Cycloolefin-Based Polymer Film:

Regarding the materials and methods employing the materials for preparing the cycloolefin-based polymer film, details are described in JP-A 2006-293342, [0098]-[0193], which can be referred to in the invention. Examples of the retardation film, constituting the second retardation region, include norbornene-based polymers such as ARTON (manufactured by JSR Corporation, and ZEONOR (manufactured by ZEON Corporation).

Various methods may be used for producing the retardation film constituting the rear-side or front-side retardation region. For example, a solution casting method, melt-extrusion method, calendar method or condensing forming method may be used. Among these, a solution casting method and melt-extrusion method are preferable. And the retardation film constituting the second retardation region may be a film prepared by being subjected to a stretching treatment after forming. Stretching the film may be carried out according to a monoaxially or biaxially stretching method. Simultaneously- or successively-biaxially stretching is preferable. For achieving high optical anisotropy, a film should be subjected to a stretching treatment by a high stretching ratio. For example, the film is preferably subjected to a stretching treatment in both of the width direction and the lengthwise direction (machine direction). The stretching ratio is preferably from 3 to 100%. The stretching treatment may be carried out by using a tenter. Or the longitudinally stretching treatment may be carried out between the rolls.

The retardation film constituting the rear-side or front-side retardation region may be a layer formed of a liquid crystal composition fixed in a desired alignment state, or a lamination containing such a layer and a polymer film supporting the layer. In the latter embodiment, the polymer film may be used as a protective film of the polarizing element. Examples of the liquid crystal which can be used for preparing the retardation film constituting the front-side retardation region include rod-like liquid crystals, discotic liquid crystals and cholesteric liquid crystals.

As a solvent cast method, solution lamination-casting method such as co-solvent cast method, solution successive-casting method and coating method may be used. Using a co-solvent cast method or successive-solvent method, plural cellulose acylate solutions (dopes) for forming the layers respectively are prepared. According to a solution co-casting method (simultaneous multilayered casting), each dope for each layer of plural layers (for example three or more layers) is extruded simultaneously from each slit on a casting-support (such as band or drum) by using a geeser for casting, then peeled off from the support at an appropriate time, and then dried to form a film.

According to a solution successive-casting method, at first, a dope of the first layer is extruded from a geeser for casting to be cast on a support; and, after being dried or not being dried, then a dope for the second layer is extruded from the geeser for casting to be cast on the first layer. And if necessary, the three or more dopes are successively cast and laminated in this manner, then removed from the support at the appropriate time, and dried to form a film.

According to a coating method, generally, a core layer is prepared according to a solution casting method. And then, a prepared coating liquid is applied to the surfaces of the core layer respectively or simultaneously by using an appropriate apparatus and dried to form a layered film.

For reducing unevenness at the corner-side, it is necessary to reduce the deformation of the retardation film caused by external force to be applied to the film. The thickness of the retardation film disposed at the rear-side, constituting the second retardation region is preferably equal to or more than 20 micro meters and equal to or less than 200 micro meters, in terms of reducing unevenness at the corner-side and improving the productivity. Details regarding unevenness at the corner-side are described in JP-A 2009-69720.

### 2. Polarizing Element

The polarizing element disposed at the front-side or rear-side is not limited. Any normal linear polarizing film can be used. The linear polarizing film is preferably a coated polarizing film as represented by a product of Optiva Inc., or a polarizing film formed by a binder and iodine or a dichroic dye. In the linear polarizing film, iodine or dichroic dye is aligned in the binder to exhibit a polarizing ability. The iodine or dichroic dye is preferably aligned along the binder molecules, or by an auto-texturing as in liquid crystal. The currently available commercial polarizer is generally prepared by immersing a stretched polymer film in a solution of iodine or a dichroic dye in a bath, thereby penetrating iodine or dichroic dye into the binder.

### 3. Protective Film

To the both surfaces of the front-side or rear-side polarizing element, a protective film is preferably bonded. Each of the protective films disposed at the liquid crystal cell side constitutes a part of the rear-side or front-side retardation regions, and the former is required to satisfy the above formula (I). The latter constitutes a part of the front-side retardation region, and in some embodiments, it is required to exhibit the optical properties, which can contribute to improving the viewing angle CR, alone or in combination with other layer(s).

The protective film disposed on the outside of the front-side or rear-side polarizing element is especially not limited. Any polymer films may be used. Examples of the film are same as those which are exemplified above as examples of the retardation film constituting the first retardation region. For example, films containing cellulose acylate (e.g., cellulose acetate, cellulose propionate and cellulose butyrate), polyolefin (e.g., norbornene-based polymer, and polypropylene), poly(meth)acrylic acid ester (e.g., polymethylmethacrylate), polycarbonate, polyester or polysulfones as a major ingredient are exemplified. Commercially available polymer films (e.g., regarding cellulose acylate film, “TD80UL” (manufactured by FUJIFILM), and regarding norbornene-based polymer film, ARTON (manufactured by JSR) and ZEONOR (manufactured by NIPPON ZEON)) can be also used.

### EXAMPLES

The invention is described in more detail with reference to the following Examples. In the following Examples, the amount of the material, reagent and substance used, their ratio, the operation with them and the like may be suitably modified or changed not overstepping the sprit and the scope of the invention. Accordingly, the scope of the invention should not be limited to the following Examples.

### 1. Preparation of Films 1 to 25:

### (1) Preparation of Film 1:

A commercial cellulose acylate film, Z-TAC (trade name by FUJIFILM) was prepared, and this was used as Film 1.

### (2) Preparation of Film 2:

A commercial cellulose acylate film, FUJITAC TD80UL (trade name by FUJIFILM) was prepared, and this was used as Film 2.

### (3) Production of Film 3:

A stretched film (protective film A) was produced according to the description in JP-A 2007-127893, [0223]-[0226]. An easy-adhesion layer-coating composition P-2 was prepared according to the description of the patent publication, and [0233], and the composition was applied onto the surface of the stretched film, protective film A, according to the description in the patent publication, [0246], thereby forming an easy-adhesion layer thereon. The film was used as Film 3.

### (4) Production of Film 4:

A cellulose acylate was prepared, of which the type of the acyl group and the degree of substitution are shown in the following Table. Concretely, a catalyst, sulfuric acid (in an amount of 7.8 parts by mass relative to 100 parts by mass of cellulose) was added to cellulose, and then a carboxylic acid to give the acyl group was added thereto, and the cellulose was acylated at 40° C. In this, the type and the amount of the carboxylic acid were changed to thereby change and control the type of the acyl group and the degree of substitution with the acyl group. After the acylation, the product was aged at 40° C. The low-molecular component was removed from the cellulose acylate by washing with acetone. In the Table, Ac means an acetyl group, and CTA means cellulose triacetate (cellulose ester derivative in which the acyl groups are all acetate groups).

### (Cellulose Acylate Solution)

The following composition was put into a mixing tank and stirred to dissolve the ingredients. After heated at 90° C. for about 10 minutes, this was filtered through a paper filter having a mean pore size of 34 μm and a sintered metal filter having a mean pore size of 10 μm.

Cellulose Acylate Solution

| | |
|---|---|
| CTA in Table below | 100.0 mas. pts. |
| Triphenyl phosphate (TPP) | 7.8 mas. pts. |
| Biphenyldiphenyl phosphate (BDP) | 3.9 mas. pts. |
| Methylene chloride | 403.0 mas. pts. |
| Methanol | 60.2 mas. pts. |

### (Mat Agent Dispersion)

The following composition containing the cellulose acylate solution that had been prepared according to the above method was put into a disperser and dispersed to prepare a mat agent dispersion.

Mat Agent Dispersion

| | |
|---|---|
| Silica particles having a mean particle size of 16 nm | 2.0 mas. pts. |
| (Aerosil R972, by Nippon Aerosil) | |
| Methylene chloride | 72.4 mas. pts. |
| Methanol | 10.8 mas. pts. |
| Cellulose acylate solution | 10.3 mas. pts. |

### (Additive Solution)

The following composition containing the cellulose acylate solution that had been prepared according to the above method was put into a mixing tank and dissolved by stirring under heat to prepare an additive solution.

Additive Solution

| | |
|---|---|
| Retardation enhancer (1) | 20.0 mas. pts. |
| Methylene chloride | 58.3 mas. pts. |
| Methanol | 8.7 mas. pts. |
| Cellulose acylate solution | 12.8 mas. pts. |

100 parts by mass of the cellulose acylate solution, 1.35 parts by mass of the mat agent dispersion, and the additive solution in such an amount that the amount of the retardation enhancer (1) in the cellulose acylate film to be formed could be 10 parts by mass were mixed to prepare a dope for film formation. The amount of the additive is by mass relative to 100 parts by mass of the amount of the cellulose acylate.

The abbreviations of the additive and the plasticizer in the following Table are as follows:

CTA: triacetyl cellulose
TPP: triphenyl phosphate
BDP: biphenyldiphenyl phosphate

### Retardation Enhancer (1):

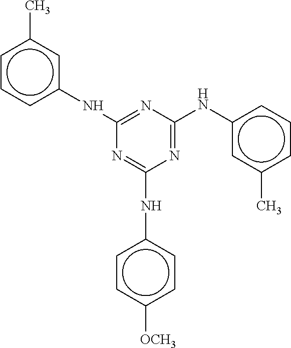

Using a band caster, the above dope was cast. The film having a residual solvent amount shown in the following Table was peeled away from the band, and in the section from the peeling to the tenter, this was stretched in the machine direction at the draw ratio shown in the following Table, and then, using a tenter, stretched in the cross direction at the draw ratio shown in the following Table. Immediately after the cross stretching, the film was shrunk (relaxed) in the cross direction at the ratio shown in the following Table, and then the film was removed from the tenter. The process gave a cellulose acylate film. The residual solvent amount in the film removed from the tenter was as in the following Table. Both edges of the film were trimmed away before the winding zone to make the film have a width of 2000 mm, and the film was wound up into a roll film having a length of 4000 m. The draw ratio in stretching is shown in the following Table.

TABLE 4

| Cellulose acylate film | | Film 4 |
|---|---|---|
| | Cellulose Type | CTA |
| | Total degree of substitution | 2.81 |
| | Ratio of 6-positoon substitution | 0.320 |
| | Degree of 6-position substitution | 0.9 |
| | Substituent | Ac |
| Additive | Additive type | Retardation enhancer (1) |
| | Amount | 10 |
| | [parts by mass relative to 100 parts by | |
| | mass of cellulose] | |
| Plasticizer | Plasticizer type | TPP/BDP |
| | Amount | 7.8/3.9 |
| | [parts by mass relative to 100 parts by | |
| | mass of cellulose] | |
| Stretching | Ratio of longwise stretching [%] | 20 |
| condition | Ratio of cross stretching [%] | 40 |
| | Ratio of shrinking [%] | 7 |
| | Stretching speed [%/min] | 35 |
| | Film surface temperature [° C.] | 120 |
| | Amount of residual solvent at the time | 50 |
| | of peeling off [%] | |
| | Amount of residual solvent at the time | 10 |
| | of termination of stretching [%] | |

Thus produced, the cellulose acylate film was used as Film 4.

### (5) Production of Film 5:

A film was produced in the same manner as that of Film 4, for which, however, cellulose acylate shown in the following Table was used as the starting material and the production condition was changed as in the following Table; and the film is Film 5. The abbreviations of the additive and the plasticizer shown below are the same as above.

TABLE 5

| Cellulose acylate film | | Film 5 |
|---|---|---|
| | Cellulose Type | CTA |
| | Total degree of substitution | 2.81 |
| | Ratio of 6-positoon substitution | 0.320 |
| | Degree of 6-position substitution | 0.9 |
| | Substituent | Ac |
| Additive | Additive type | Retardation enhancer (1) |
| | Amount | 7 |
| | [parts by mass relative to 100 parts by | |
| | mass of cellulose] | |
| Plasticizer | Plasticizer type | TPP/BDP |
| | Amount | 7.8/3.9 |
| | [parts by mass relative to 100 parts by | |
| | mass of cellulose] | |
| Stretching | Ratio of longwise stretching [%] | 28 |
| condition | Ratio of cross stretching [%] | 60 |
| | Ratio of shrinking [%] | 7 |
| | Stretching speed [%/min] | 100 |
| | Film surface temperature [° C.] | 160 |
| | Amount of residual solvent at the time | 45 |
| | of peeling off [%] | |
| | Amount of residual solvent at the time | 10 |
| | of termination of stretching [%] | |

Thus produced, the cellulose acylate film was used as Film 5.

### (6) Production of Film 6:

A film was produced in the same manner as that of Film 4, for which, however, cellulose acylate shown in the following Table was used as the starting material and the production condition was changed as in the following Table; and the film was used as Film 6. The abbreviations of the additive and the plasticizer shown below are the same as above.

TABLE 6

| Cellulose acylate film | | Film 6 |
|---|---|---|
| | Cellulose Type | CTA |
| | Total degree of substitution | 2.81 |
| | Ratio of 6-positoon substitution | 0.320 |
| | Degree of 6-position substitution | 0.9 |
| | Substituent | Ac |
| Additive | Additive type | Retardation enhancer (1) |
| | Amount | 6.4 |
| | [parts by mass relative to 100 parts by | |
| | mass of cellulose] | |
| Plasticizer | Plasticizer type | TPP/BDP |
| | Amount | 7.8/3.9 |
| | [parts by mass relative to 100 parts by | |
| | mass of cellulose] | |
| Stretching | Ratio of longwise stretching [%] | 3 |
| condition | Ratio of cross stretching [%] | 32 |
| | Ratio of shrinking [%] | 7 |
| | Stretching speed [%/min] | 35 |
| | Film surface temperature [° C.] | 120 |
| | Amount of residual solvent at the time | 50 |
| | of peeling off [%] | |
| | Amount of residual solvent at the time | 10 |
| | of termination of stretching [%] | |

### (7) Production of Film 7:

The norbornene-based film fitted to a liquid-crystal panel “32C7000” by TOSHIBA was peeled away; and an easy-adhesion layer was formed on the surface of the film in the same manner as that for Film 2. The film was used as Film 7. The film thickness was 70 μm.

### (8) Production of Film 8:

Cellulose acylate propionate, CAP482-20 (by Eastman Chemical, having a degree of acetyl substitution of 0.2 and a degree of propionyl substitution of 2.4) was prepared. A plasticizer, 1,4-phenylene-tetraphenyl phosphate (8% by mass) and an antiaging agent (antioxidant), IRGANOX-1010 (by Ciba Specialty Chemicals) (0.5% by mass) were added thereto, and mixed for 30 minutes with a tumbler mixer. The resulting mixture was dried with a moisture-removing hot air drier (Matsui Seisakusho's DMZ2), at a hot air temperature of 150° C. and at a dew point of −36° C. Next, the mixture was fed into a double-screw extruder (by Technovel); and with adding thereto a mat agent, AEROSIL 200V (0.016-μm silica fine particles by Nippon Aerosil) through the additive hopper port provided in the intermediate part of the extruder via a continuous feeder so that its throughput flow could be 0.05%, and also thereto, a UV absorbent, TINUVIN 360 (by Ciba Specialty Chemicals) through the same port to be at a throughput flow of 0.5%, the mixture was melt-extruded. Thus melt-extruded, the film formed had a thickness of 180 μm.

The film was monoaxially stretched by 2.2 times in TD at 142° C. with its edges kept fixed. This was used as Film 8.

The film thickness was 85 μm.

In this Example, the film formed of a starting material, cellulose acylate propionate (CAP) was produced according to a melt extrusion method. Needless-to-say, the inventors have confirmed that the same film having the same characteristics can also be produced according to a solution casting method, and the film exhibits the same effect. (However, in consideration of the solubility of CAP in dope preparation, CAP having a degree of acetyl substitution of 1.6 and a degree of propionyl substitution of 0.9 was used as the starting material.)

### (9) Production of Film 9:

17.77 g (40 mmol) of 2,2′-bis(3,4-dicarboxyphenyl)-hexafluoropropane dianhydride and 12.81 g (40 mmol) of 2,2-bis(trifluoromethyl)-4,4′-diaminobiphenyl were put into a reactor (500 mL) equipped with a mechanical stirrer, a Dean Stark device, a nitrogen-introducing duct, a thermometer, and a condenser tube. Subsequently, a solution of 2.58 g (20 mmol) of isoquinoline dissolved in 275.21 g of m-cresol was added to it, and stirred at 23° C. for 1 hour (at 600 rpm) to prepare a uniform solution. Next, the reactor was heated with an oil bath so that its inner temperature could be 180±3° C., and with the reactor kept at the temperature, this was stirred for 5 hours to give a yellow solution. This was further stirred for 3 hours, then heating and stirring was stopped, and the solution was kept cooled to room temperature thereby giving a precipitate of polymer gel.

Acetone was added to the gel in the reactor, and the gel was completely dissolved therein to give a diluted solution (7% by weight). The diluted solution was added to 2 L of isopropyl alcohol kept stirred, little by little to give a precipitate of white powder. The powder was collected through filtration, put into 1.5 L of isopropyl alcohol and washed. The same operation was repeated once more for washing, and the powder was again collected through filtration. This was dried in an air-circulating hematothermal oven at 60° C. for 48 hours, and then dried at 150° C. for 7 hours to give a polyimide having a recurring unit of the following formula (I as a white powder (yield 85%). The weight-average molecular weight (Mw) of the polyimide was 124,000, and the degree of imidation thereof was 99.9%.

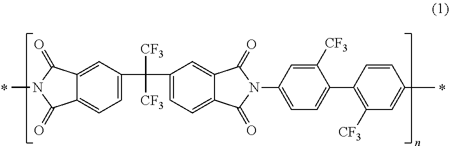

17.7 parts by weight of the above-produced polyimide (white powder) was dissolved in 100 parts by weight of methyl isobutyl ketone (boiling point 116° C.) to prepare a 15-wt. % polyimide solution. Using a rod coater, the polyimide solution was applied in one direction on the surface of the anchor coat layer of an anchor coat layer-having transparent film. Next, in an air-circulating hematothermal oven at 135±1° C., this was dried for 5 minutes to remove the solvent through evaporation, thereby producing a transparent film (overall thickness 83.8 μm) having a 3.0 μm-thick polyimide layer. Subsequently, using a tenter stretcher, the polyimide layer-having transparent film was monoaxially stretched by 1.22 times in the transverse direction with the machine direction of the film kept fixed, while kept heated in an air-circulating hematothermal over at 150±1° C., and then relaxed by 0.97 times in the transverse direction to give a laminate film. After thus stretched, the laminate film was used as Film 9.

### (10) Production of Film 10:

A cellulose acylate film was produced in the same manner as that for Film 5, for which, however, cellulose acylate shown in the following Table was used, the amount of the retardation enhancer (1) to be added was changed as in the following Table, and the stretching condition was changed as in the Table. The film was used as Film 10. The abbreviations of the additive and the plasticizer in the following Table are the same as above.

TABLE 7

| Cellulose acylate film | | Film 10 |
|---|---|---|
| | Cellulose Type | CTA |
| | Total degree of substitution | 2.81 |
| | Ratio of 6-positoon substitution | 0.320 |
| | Degree of 6-position substitution | 0.9 |
| | Substituent | Ac |
| Additive | Additive type | Retardation enhancer (1) |
| | Amount | 2.2 |
| | [parts by mass relative to 100 parts by | |
| | mass of cellulose] | |
| Plasticizer | Plasticizer type | TPP/BDP |
| | Amount | 7.8/3.9 |
| | [parts by mass relative to 100 parts by | |
| | mass of cellulose] | |
| Stretching | Ratio of longwise stretching [%] | 6 |
| condition | Ratio of cross stretching [%] | 47 |
| | Ratio of shrinking [%] | 7 |
| | Stretching speed [%/min] | 35 |
| | Film surface temperature [° C.] | 120 |
| | Amount of residual solvent at the time | 55 |
| | of peeling off [%] | |
| | Amount of residual solvent at the time | 12 |
| | of termination of stretching [%] | |

### (11) Production of Film 11:

A cellulose acylate film was produced in the same manner as that for Film 5, for which, however, cellulose acylate shown in the following Table was used, the amount of the retardation enhancer (1) to be added was changed as in the following Table, and the stretching condition was changed as in the Table. The film was used as Film 11. The abbreviations of the additive and the plasticizer in the following Table are the same as above.

TABLE 8

| Cellulose acylate film | | Film 11 |
|---|---|---|
| | Cellulose Type | CTA |
| | Total degree of substitution | 2.87 |
| | Ratio of 6-positoon substitution | 0.316 |
| | Degree of 6-position substitution | 0.907 |
| | Substituent | Ac |
| Additive | Additive type | Retardation enhancer (1) |
| | Amount | 1.4 |
| | [parts by mass relative to 100 parts by | |
| | mass of cellulose] | |
| Plasticizer | Plasticizer type | TPP/BDP |
| | Amount | 7.8/3.9 |
| | [parts by mass relative to 100 parts by | |
| | mass of cellulose] | |
| Stretching | Ratio of longwise stretching [%] | 1 |
| condition | Ratio of cross stretching [%] | 5 |
| | Ratio of shrinking [%] | 1 |
| | Stretching speed [%/min] | 70 |
| | Film surface temperature [° C.] | 120 |
| | Amount of residual solvent at the time | 75 |
| | of peeling off [%] | |
| | Amount of residual solvent at the time | 20 |
| | of termination of stretching [%] | |

### (12) Production of Film 12:

A cellulose acylate film was produced in the same manner as that for Film 11, for which, however, the amount of the retardation enhancer (1) to be added was changed from 1.4 parts by mass to 1.5 parts by mass. The film was used as Film 12.

### (13) Production of Film 13:

Cellulose acetate benzoate 13A was produced according to the production method for the comparative compound C-3 in JP-A 2008-95027, for which, however, 4-methoxycinnamic acid chloride used as the intermediate 2 was changed to benzoyl chloride.

### <Preparation of Cellulose Acylate Solution>

The following materials were put into a mixing tank and stirred under heat to dissolve the ingredients, thereby preparing a cellulose acylate solution.

Cellulose Acylate Solution

| | | |
|---|---|---|
| Cellulose acetate benzoate 13A | 100 | mas. pts. |
| Methylene chloride | 403.0 | mas. pts. |
| Methanol | 60.2 | mas. pts. |

The thus-prepared cellulose acylate solution was immediately cast, using a band caster. The film having a residual solvent amount of about 30% by mass was dried with hot air at 160° C. applied thereto, using a tenter.

Further, the film was monoaxially stretched by 1.5 times at a temperature of 160° C., with its edges kept fixed. This was used as Film 13. The film thickness was 55 μm.

### (14) Production of Film 14:

### <Production of Cyclic Polyolefin Polymer P-1>

100 parts by mass of pure toluene and 100 parts by mass of methyl norbornene-carboxylate were put into a reactor. Next, 25 mmol % (relative to the monomer) of ethyl hexanoate-Ni and 0.225 mol % (relative to the monomer) of tri(pentafluorophenyl)boron dissolved in toluene, and 0.25 mol % (relative to the monomer) of triethylaluminium dissolved in toluene were added to the reactor. With stirring at room temperature, these were reacted for 18 hours. After the reaction, the reaction mixture was put into excessive methanol to form a polymer precipitate. The precipitate was purified, and the resulting cyclic polyolefin polymer (P-1) was dried in vacuum at 65° C. for 24 hours.

The produced polymer was dissolved in tetrahydrofuran, and its molecular weight was measured through gel permeation chromatography. The polystyrene-equivalent, number-average molecular weight of the polymer was 79,000, and the weight-average molecular weight thereof was 205,000. The produced polymer was analyzed with an Abbe's refractiometer, and its refractive index was 1.52.

### (Polyolefin Dope D-1)

| | | |
|---|---|---|
| Cyclic polyolefin polymer P-1 | 150 | mas. pts. |
| Additive, polymethyl acrylate (Soken Chemical′s | 7.5 | mas. pts. |
| Actflow UMM 1001; weight-average molecular | | |
| weight Mw, about 1000) | | |
| Antioxidant, Ciba Specialty Chemicals′ | 0.45 | mas. pts. |
| IRGANOX 1010 | | |
| Dichloromethane | 620 | mas. pts. |

The above composition was put into a mixing tank and stirred to dissolve the ingredients. The solution was filtered through a paper filter having a mean pore size of 34 μM and a sintered metal filter having a mean pore size of 10 μM thereby preparing a cyclic polyolefin dope D-1. The dope was cast, using a band caster. Peeled from the band, the film having a residual solvent amount of about 30% by mass was dried with hot air at 140° C. applied thereto, using a tenter. Subsequently, the tenter transference was changed to roll transference, and the film was further dried at 120° C. to 140° C. and wound up. The film was used as Film 14. The film thickness was 80 μm.

### (15) Production of Film 15:

### (Cellulose Acylate Solution for Low-Substitution Layer)

The following composition was put into a mixing tank and stirred under heat to dissolve the ingredients, thereby preparing a cellulose acylate solution for low-substitution layer.

| | | |
|---|---|---|
| Cellulose acetate having a degree | 100.0 | mas. pts. |
| of substitution of 2.43 | | |
| Retardation enhancer (1) | 4.0 | mas. pts. |
| Retardation enhancer (2) | 10.0 | mas. pts. |
| Methylene chloride | 351.5 | mas. pts. |
| Methanol | 52.5 | mas. pts. |

The composition of the retardation enhancer (2) is shown in the following Table 7. In the following Table, EG means ethylene glycol, PG means propylene glycol, BG means butylene glycol, TPA means terephthalic acid, PA means phthalic acid, AA means adipic acid, SA means succinic acid. The retardation enhancer (2) is a non-phosphate compound, and is a compound functioning as a retardation enhancer. The terminal of the retardation enhancer (2) is blocked with an acetyl group.

TABLE 9

| | Glycol unit | | | | Dicarboxylic acid unit | | | |
|---|---|---|---|---|---|---|---|---|
| | Ratio of | | | Averaged | | | Averaged | |
| | blocking | | | number of | | | number of | |
| Retardation | both terminal | EG | PG | carbon | TPA | SA | carbon | Molecular |
| enhancer | hydroxyls(%) | (%) | (%) | atoms | (mole %) | (mole %) | atoms | weight |
| (2) | 100 | 50 | 50 | 2.5 | 55 | 45 | 6.2 | 730 |

### (Cellulose Acylate Solution for High-Substitution Layer)

The following composition was put into a mixing tank and stirred to dissolve the ingredients, thereby preparing a cellulose acylate solution for high-substitution layer.

| | | |
|---|---|---|
| Cellulose acetate having a degree | 100.0 | mas. pts. |
| of substitution of 2.79 | | |
| Retardation enhancer (2) | 11.0 | mas. pts. |
| Silica particles having a mean | 0.15 | mas. pts. |
| particle size of 16 nm | | |
| (Aerosil R972, by Nippon Aerosil) | | |
| Methylene chloride | 395.0 | mas. pts. |
| Methanol | 59.0 | mas. pts. |

### (Production of Cellulose Acylate Sample)

The two cellulose acylate solutions were cast onto a band to form thereon a core layer having a thickness of 82 μm from the cellulose acylate solution for low-substitution layer and to form a skin layer A and a skin layer B each having a thickness of 2 μm from the cellulose acylate solution for high-substitution layer. The formed film was peeled away from the band, clipped, and stretched in the transverse direction by 18% at a stretching temperature of 180° C. while the residual solvent amount was 20% relative to the total mass of the film, using a tenter. Next, the film was unclipped and dried at 130° C. for 20 minutes. This was used as Film 15.

The production of Film 15 was free from the problems with the production of Film 4 (smoking in high-temperature treatment in the drying step, adhesion of vaporized oil to the parts of the machine to cause operation failure or adhesion thereof to film to cause surface failure of the film).

This is because the retardation enhancer (2) used in the production of Film 15 functions also as a plasticizer, and therefore, the production of Film 15 does not require the conventional low-molecular-weight plasticizers TPP and BP as in the production of Film 4.

Use of the compound having a positive birefringence such as the retardation enhancer (2) solves the above-mentioned problems, and therefore, it may be said that the compound having a positive birefringence is a preferred retardation enhancer for film production.

### (16) Production of Film 16:

### (Cellulose Acylate Solution for Low-Substitution Layer)

The following composition was put into a mixing tank and stirred under heat to dissolve the ingredients, thereby preparing a cellulose acylate solution for low-substitution layer.

| | | |
|---|---|---|
| Cellulose acetate having a degree | 100.0 | mas. pts. |
| of substitution of 2.43 | | |
| Retardation enhancer (2) | 18.5 | mas. pts. |
| Methylene chloride | 365.5 | mas. pts. |
| Methanol | 54.6 | mas. pts. |

### (Cellulose Acylate Solution for High-Substitution Layer)

The following composition was put into a mixing tank and stirred to dissolve the ingredients, thereby preparing a cellulose acylate solution for high-substitution layer.

| | | |
|---|---|---|
| Cellulose acetate having a degree | 100.0 | mas. pts. |
| of substitution of 2.79 | | |
| Retardation enhancer (2) | 11.0 | mas. pts. |
| Silica particles having a mean | 0.15 | mas. pts. |
| particle size of 16 nm | | |
| (Aerosil R972, by Nippon Aerosil) | | |
| Methylene chloride | 395.0 | mas. pts. |
| Methanol | 59.0 | mas. pts. |

### (Production of Cellulose Acylate Sample)

The two cellulose acylate solutions were cast onto a band to form thereon a core layer having a thickness of 37 μm from the cellulose acylate solution for low-substitution layer and to form a skin layer A and a skin layer B each having a thickness of 2 μm from the cellulose acylate solution for high-substitution layer. The formed film was peeled away from the band, dried at a temperature of 200° C. for 30 minutes while the residual solvent amount was 20% relative to the total mass of the film, and then further dried at 130° C. for 20 minutes. This was used as Film 16.

### (17) Production of Film 17:

A commercial norbornene polymer film, ZEONOR ZF14-060 (by Optes) was processed for corona discharge treatment on the surface thereof, using a solid state corona discharger, 6 KVA (by Pillar). This was used as Film 17. The thickness of the film was 60 μm.

### (18) Production of Film 18:

A commercial cycloolefin polymer film, ARTON FLZR50 (by JSR) was processed for corona discharge treatment on the surface thereof, in the same manner as that for Film 17. This was used as Film 18. The thickness of the film was 50 μm.

### (19) Production of Film 19:

### (Cellulose Acylate Solution for Low-Substitution Layer)

The following composition was put into a mixing tank and stirred under heat to dissolve the ingredients, thereby preparing a cellulose acylate solution for low-substitution layer.

| | | |
|---|---|---|
| Cellulose acetate having a degree | 100.0 | mas. pts. |
| of substitution of 2.43 | | |
| Retardation enhancer (2) | 18.5 | mas. pts. |
| Methylene chloride | 365.6 | mas. pts. |
| Methanol | 54.6 | mas. pts. |

### (Cellulose Acylate Solution for High-Substitution Layer)

The following composition was put into a mixing tank and stirred to dissolve the ingredients, thereby preparing a cellulose acylate solution for high-substitution layer.

| | | |
|---|---|---|
| Cellulose acetate having a degree | 100.0 | mas. pts. |
| of substitution of 2.79 | | |
| Retardation enhancer (2) | 11.0 | mas. pts. |
| Silica particles having a mean | 0.15 | mas. pts. |
| particle size of 16 nm | | |
| (Aerosil R972, by Nippon Aerosil) | | |
| Methylene chloride | 395.0 | mas. pts. |
| Methanol | 59.0 | mas. pts. |

### (Production of Cellulose Acylate Sample)

The two cellulose acylate solutions were cast onto a band to form thereon a core layer having a thickness of 65 μm from the cellulose acylate solution for low-substitution layer and to form a skin layer A and a skin layer B each having a thickness of 2 μm from the cellulose acylate solution for high-substitution layer. The formed film was peeled away from the band, clipped, and stretched in the transverse direction by 60% at a stretching temperature of 200° C. while the residual solvent amount was 20% relative to the total mass of the film, using a tenter. Next, the film was unclipped and dried at 130° C. for 20 minutes. This was used as Film 19.

### (20) Production of Film 20:

A commercial cellulose acylate film, FUJITAC TDN80ULV (by FUJIFILM) was prepared. This was used as Film 20.

### (21) Production of Film 21:

Using a polyvinyl adhesive, Film 2 and Film 20 were stuck together with their slow axes kept perpendicular to each other. The resulting laminate film was used as Film 21.

### (22) Production of Film 22:

Film 22 having a thickness of 34 μm was produced according to the same method as that for the film sample 201 in JP-A 2009-63983.

### (23) Production of Film 23:

A commercial norbornene-based polymer film “ZEONOR ZF 14-100” (by Optes) was biaxially stretched by 1.5 times in MD and by 1.5 times in TD with their edges kept fixed, at 153° C., and then processed for corona discharge treatment on the surface thereof. This was used as Film 23. The thickness of the film was 45 μm.

### (24) Production of Film 24:

### (Cellulose Acylate Solution for Low-Substitution Layer)

The following composition was put into a mixing tank and stirred under heat to dissolve the ingredients, thereby preparing a cellulose acylate solution for low-substitution layer.

| | | |
|---|---|---|
| Cellulose acetate having a degree | 100.0 | mas. pts. |
| of substitution of 2.43 | | |
| Retardation enhancer (2) | 17.0 | mas. pts. |
| Methylene chloride | 361.8 | mas. pts. |
| Methanol | 54.1 | mas. pts. |

### (Cellulose Acylate Solution for High-Substitution Layer)

The following composition was put into a mixing tank and stirred to dissolve the ingredients, thereby preparing a cellulose acylate solution for high-substitution layer.

| | | |
|---|---|---|
| Cellulose acetate having a degree | 100.0 | mas. pts. |
| of substitution of 2.79 | | |
| Retardation enhancer (2) | 11.0 | mas. pts. |
| Silica particles having a mean | 0.15 | mas. pts. |
| particle size of 16 nm | | |
| (Aerosil R972, by Nippon Aerosil) | | |
| Methylene chloride | 395.0 | mas. pts. |
| Methanol | 59.0 | mas. pts. |

### (Production of Cellulose Acylate Sample)

The two cellulose acylate solutions were cast onto a band to form thereon a core layer having a thickness of 114 μm from the cellulose acylate solution for low-substitution layer and to form a skin layer A and a skin layer B each having a thickness of 2 μm from the cellulose acylate solution for high-substitution layer. The formed film was peeled away from the band, clipped, and conveyed using a tenter at a temperature of 170° C. while the residual solvent amount was 20% relative to the total mass of the film, using a tenter. Next, the film was unclipped, then dried at 130° C. for 20 minutes, then stretched by 23% in the transverse direction at a stretching temperature of 180° C. and further stretched in the transverse direction using a tenter. This was used as Film 24.

### (25) Production of Film 25:

A cellulose acylate film was produced in the same manner as that for Film 6, for which, however, the draw ratio in transverse-direction stretching was changed from 32% to 35%. The film was used as Film 25.

### 2. Characteristic of Films 1 to 25:

The characteristics of Films 1 to 25 produced in the above are shown in the following Table. Re(590) and Rth(590) of each film were measured as follows: The sample (30 mm×40 mm) was conditioned at 25° C. and 60% RH for 2 hours, and analyzed with KOBRA 21ADH (by Oji Scientific Instruments) at a wavelength of 590 nm. For Films 1, 2, 4 to 6, 8, 10 to 13, 15, 16, 19 to 22, and 24 to 25, an assumed mean refractive index of 1.48 and the film thickness were inputted and the data were computed. For the other Films, the assumed refractive index was 1.53 for Films 7, 17 and 23, 1.58 for Film 9, 1.50 for Film 3, 1.52 for Films 14 and 18.

TABLE 10

| | Thickness | Re590) | Rth590) |
|---|---|---|---|
| Film | (μm) | (nm) | (nm) |
| Film 1 | 60 | 1 | −1 |
| Film 2 | 80 | 2 | 45 |
| Film 3 | 30 | 0.8 | 1.5 |
| Film 4 | 80 | 60 | 250 |
| Film 5 | 65 | 70 | 205 |
| Film 6 | 80 | 55 | 200 |
| Film 7 | 70 | 61 | 208 |
| Film 8 | 85 | 70 | 205 |
| Film 9 | 80 | 60 | 250 |
| Film 10 | 80 | 83 | 165 |
| Film 11 | 80 | 3 | 90 |
| Film 12 | 80 | 3 | 95 |
| Film 13 | 55 | 275 | −69 |
| Film 14 | 80 | 30 | 250 |
| Film 15 | 86 | 60 | 250 |
| Film 16 | 41 | 0.5 | 45 |
| Film 17 | 60 | 1.8 | 3.1 |
| Film 18 | 50 | 1.7 | 3.1 |
| Film 19 | 69 | 105 | 110 |
| Film 20 | 80 | 3.5 | 53 |
| Film 21 | 160 | 1.6 | 97 |
| Film 22 | 34 | 1.9 | 41 |
| Film 23 | 45 | 0.2 | 43 |
| Film 24 | 118 | 61.5 | 210 |
| Film 25 | 82 | 60.5 | 207.8 |

In the same manner as above, Re and Rth of the Films in the following Table at a wavelength of 450 nm, 550 nm or 630 nm were determined.

TABLE 11

| | | | | Wavelength- | | | | Wavelength- |
|---|---|---|---|---|---|---|---|---|
| | Re(nm) | | | dispersion | Rth(nm) | | | dispersion |
| | 450 nm | 550 nm | 630 nm | *1 | 450 nm | 550 nm | 630 nm | *1 |
| Film 2 | −3.3 | 0.8 | 3.2 | Reversed | 32 | 43 | 47 | Reversed |
| Film 7 | 61 | 61 | 61 | Flat | 208 | 208 | 208 | Flat |
| Film 22 | 2.6 | 2.1 | 1.7 | Normal | 54 | 43 | 40 | Normal |
| Film 23 | 0.2 | 0.2 | 0.2 | Flat | 43 | 43 | 43 | Flat |
| Film 24 | 58.5 | 61 | 62 | Reversed | 201 | 208 | 211 | Reversed |
| Film 25 | 64.5 | 61 | 60 | normal | 214 | 208 | 207.5 | normal |

*1 “reversed”: Re or Rth shows the reversed wavelength-dispersion; “flat”: Re or Rth is constant with wavelength variation; “normal”: Re or Rth shows the normal wavelength-dispersion

### 3. Production of Polarizers:

A polyvinyl alcohol (PVA) film having a thickness of 80 μm was dyed by dipping it in an aqueous iodine solution having an iodine concentration of 0.05% by mass at 30° C. for 60 seconds, then stretched in the machine direction by 5 times the original length while dipped in an aqueous boric acid solution having a boric acid concentration of 4% by mass for 60 seconds, and thereafter dried at 50° C. for 4 minutes to give a polarizing film having a thickness of 20 μm.

Of the above-mentioned films, the cellulose acylate films were saponified as follows: Each film was dipped in an aqueous sodium hydroxide solution (1.5 mol/liter) at 55° C., and then fully rinsed with water to remove sodium hydroxide. Next, this was dipped in an aqueous diluted sulfuric acid solution (0.005 mol/liter) at 35° C. for 1 minute, and then dipped in water to fully remove the aqueous diluted sulfuric acid solution. Finally, the sample was fully dried at 120° C.

Any two sheets of the films (Films 1 to 25) were combined with the polarizing film sandwiched therebetween and stuck together, using an adhesive, thereby producing a polarizer having a protective film on both surfaces thereof. The cellulose acylate films were stuck to the polarizing element, using a polyvinyl alcohol adhesive; and the other films were thereto using an acrylic adhesive. The combination is shown in Table 11 below.

In the following Table, the film with “*1” means a retardation film serving as a polarizer-protective film and disposed on the panel side further outside from the polarizing film; the film with “*2” means a retardation film serving as a polarizer-protective film and disposed between the liquid-crystal cell and the polarizing film; and the film with “3” means a retardation film serving as a polarizer-protective film and disposed on the backlight side further outside from the polarizing film. The same shall apply in all the following Tables.

Films 4 to 10, 13 to 15, 19, 24 and 25 were so stuck that the in-plane slow axis thereof could be parallel to the transmission axis of the polarizing element. Films 1 to 3, and 11, 12, 16 to 18, and 20 to 23 were so stuck that the in-plane slow axis thereof cold be perpendicular to the transmission axis of the polarizing element. In the films having an easy-adhesion layer, the easy-adhesion layer was stuck to the panel side of the polarizing element.

### 4. Production and Evaluation of VA-Mode Liquid-Crystal Display Devices:

### (1) Preparation of VA-Mode Liquid-Crystal Cells 1 to 6:

In this Example, in case where a color filer is formed on TFT, used was an organic developer CD2000 (by Fiji Film Electromaterials).

### (1)-1 Preparation of VA-Mode Liquid-Crystal Cells 1-3:

The liquid-crystal cell of a Sony's liquid-crystal panel, KDL-52W5 was prepared. The liquid-crystal cell is a COA-structured VA-mode liquid-crystal cell. This is Liquid-crystal Cell 1.

Δnd(590) of Liquid-crystal Cell 1 was measured with AXOMETRICS' AXOSCAN using the associated software, and was 295 nm.

Coloring photosensitive compositions of Examples 3, 8 and 10 in JP-A 2009-144126 were prepared. Using these and according to the process of Example 9a described in JP-T 2008-516262, [0099]-[0103], a color filer substrate was produced.

On the color filter substrate produced in the above, formed was a transparent electrode of ITO (indium tin oxide) through sputtering. Next, according to Example 1 in JP-A 2006-64921, a spacer was formed on the ITO film in the area corresponding to the upper part of the partitioning wall (black matrix).

Separately, a glass substrate was prepared with a transparent electrode of ITO formed thereon, as a counter substrate. The transparent electrode of the color filter substrate and the counter substrate was patterned for PVA mode, and a vertical alignment film of polyimide was formed thereon.

Afterwards, a UV-curable resin sealant was applied to the position corresponding to the black matrix frame disposed in the periphery to surround the RGB pixel group of the color filter, according to a dispenser system, then a PVA-mode liquid crystal was dropwise applied thereto, and the substrate was stuck to the counter substrate. The thus-stuck substrates were irradiated with UV and heat-treated to cure the sealant. According to the process, a liquid-crystal cell was produced.

Subsequently, Δnd(590) of the thus-produced liquid-crystal cell was measured with AXOMETRICS' AXOSCAN using the associated software, and the cell, of which Δnd(590) is the same 295 nm as that of Sony's KDL-52W5 employed as a COA-structured VA-mode liquid-crystal cell, was selected.

A liquid-crystal cell taken out of a liquid-crystal panel LCD-40MZW100 by Mitsubishi was disassembled to take out the array substrate disposed on the light source side, and its surface was washed with ethanol.

The above array substrate from the commercial device was stuck to the counter substrate side of the liquid-crystal cell, using a matching oil for glass, and this is Liquid-crystal Cell 2 (non-COA structure). Also using a matching oil for glass, the above array substrate was stuck to the glass filter substrate side of the liquid-crystal cell, and this is Liquid-crystal Cell 3 (COA structure).

As the light source for Liquid-crystal Cells 2 and 3, used was the backlight used in the above LCD-40MZW100, and this was disposed on the side of the array substrate.

### (1)-2 Preparation of VA-Mode Liquid-Crystal Cell 4:

According to Example 20 described in JP-A 2009-141341, a TFT element was formed on a glass substrate, and a protective film was formed on the TFT element. Subsequently, a contact hole was formed in the protective film, and then a transparent electrode of ITO was formed, as electrically connected to the TFT element, on the protective film, thereby producing an array substrate.

Using a coloring photosensitive composition prepared according to Examples 17, 18 and 19 in JP-A 2009-144126 and according to the process described in Example 9a in JP-T 2008-516262, [0099]-[0103], a color filter substrate was produced.

On the color filter substrate produced in the above, formed was a transparent electrode of ITO through sputtering. Next, according to Example 1 in JP-A 2006-64921, a spacer was formed on the ITO film in the area corresponding to the upper part of the partitioning wall (black matrix).

The transparent electrode of the array substrate and the color filter substrate was patterned for PVA mode, and a vertical alignment film of polyimide was formed thereon.

Afterwards, a UV-curable resin sealant was applied to the position corresponding to the black matrix frame disposed in the periphery to surround the RGB pixel group of the color filter, according to a dispenser system, then a PVA-mode liquid crystal was dropwise applied thereto, and the substrate was stuck to the array substrate. The thus-stuck substrates were irradiated with UV and heat-treated to cure the sealant. According to the process, a liquid-crystal cell was produced.

Subsequently, Δnd(590) of the thus-produced liquid-crystal cell was measured with AXOMETRICS' AXOSCAN using the associated software, and the cell, of which Δnd(590) is 295 nm, was selected. This was used as Liquid-crystal Cell 4.

As the light source for Liquid-crystal Cell 4, used was the backlight used in the above LCD-40MZW100, and the light source was disposed on the side of the array substrate.

### (1)-3 Preparation of VA-Mode Liquid-Crystal Cell 5:

According to Example 20 in JP-A 2009-141341, a TFT element was formed on a glass substrate, and a protective film was formed on the TFT element.

Subsequently, using a coloring photosensitive composition prepared according to Examples 17, 18 and 19 in JP-A 2009-144126 and according to the process of Example 9a in JP-T 2008-516262, [0099]-[0103], a color-filter-on-array (COA) substrate was formed on the above protective film. In this, however, the concentration of the pigment in the coloring photosensitive resin composition for each pixel was halved, and the amount of the coating composition was controlled so that the black pixel could have a thickness of 4.2 μm and the red pixel, the green pixel, and the blue pixel could have a thickness of 3.5 μm each. Further, a contact hole was formed in the color filter, and then, a transparent pixel electrode of ITO (indium tin oxide), as electrically connected to the TFT element, was formed on the color filter. Next, according to Example 1 in JP-A 2006-64921, a spacer was formed on the ITO film in the area corresponding to the upper part of the partitioning wall (black matrix).

Separately, a glass substrate was prepared with a transparent electrode of ITO formed thereon, as a counter substrate. The transparent electrode of the COA substrate and the counter substrate was patterned for PVA mode, and a vertical alignment film of polyimide was formed thereon.

Afterwards, a UV-curable resin sealant was applied to the position corresponding to the black matrix frame disposed in the periphery to surround the RGB pixel group of the color filter, according to a dispenser system, then a PVA-mode liquid crystal was dropwise applied thereto, and this was stuck to the counter substrate. The thus-stuck substrates were irradiated with UV and heat-treated to cure the sealant. According to the process, a liquid-crystal cell was produced.

Subsequently, Δnd(590) of the thus-produced liquid-crystal cell was measured with AXOMETRICS' AXOSCAN using the associated software, and the cell, of which Δnd(590) is 295 nm, was selected. This was used as Liquid-crystal Cell 5.

As the light source for Liquid-crystal Cell 5, used was the backlight used in the above LCD-40MZW100, and the light source was disposed on the side of the COA substrate.

### (1)-4 Preparation of VA-Mode Liquid-Crystal Cell 6:

Liquid-crystal Cell 6 was produced according to the same method as that for Liquid-crystal Cell 5, for which, however, the columnar spacer pattern formed in the part corresponding to the upper part of the partitioning wall on the ITO film on the COA substrate has a diameter of 16 μm and a mean height of 3.0 μm.

And of the thus-produced Liquid-crystal Cell 6 was measured with AXOMETRICS' AXOSCAN using the associated software, and Δnd(590) thereof was 240 nm.

As the light source for Liquid-crystal Cell 6, used was the backlight used in the above LCD-40MZW100, and the light source was disposed on the side of the COA substrate.

### (2) Computation of Member Contrast Ratio of the Front-Side Substrate and the Rear-Side Substrate of the Liquid-Crystal Cell:

The member contrast ratio of the rear-side substrate and the front-side substrate of the liquid-crystal cell is meant to indicate the total contrast ratio of each substrate and each member formed on each substrate. Examples of the member include all members of color filter, black matrix, array member (TFT array, etc.), projection on substrate, common electrode, slit, etc.

Two substrates, or that is the front-side substrate and the rear-side substrate to form each liquid-crystal cell were separated from each other to the individual front-side substrate and rear-side substrate; and each substrate was washed with ethanol. Subsequently, the member contrast ratio of the front-side substrate (including the front-side substrate and all the members formed on the substrate), and that of the rear-side substrate (including the rear-side substrate and all the members formed on the substrate) were computed according to the following method.

A polarizer (HLC2-2518, by Sanritz) was put on the backlight of a liquid-crystal panel, Sharp's LC-32GH5, and on this, the front-side substrate or the rear-side substrate prepared by disassembling each liquid-crystal cell, as fitted to a rotary stage SGSP-120YAW (by Sigma Koki), was disposed in parallel to each other at a distance of 2 mm from the polarizer. Briefly, these were so disposed that the TFT array wiring on the substrate and the lattice pattern of the black matrix could correspond to the polarization axis of the polarizer. Further on this, a polarizer, HLC2-2518 (by Sanritz) fitted to a rotary stage was disposed so that the distance between the polarizers could be 52 mm. Using a tester BMSA (by TOPCON) in a dark room, the brightness at the time of black level and white level of display in the normal direction was measured, and the front contrast ratio A (white brightness/black brightness) was computed. In this, the polarizer was rotated, and the lowest brightness was the brightness at the time of black level of display. Then, the polarizer was rotated by 90 degrees, and the brightness in this stage was the brightness at the time of white level of display.

Next, in the above embodiment, the front-side substrate or the rear-side substrate was removed, and the brightness at the time of black level or white level of display with the polarizer alone was measured, and the front contrast ratio B was computed.

To remove the influence of the front contrast ratio B with the polarizer on the front contrast ratio A, the member contrast ratio was computed according to the following formula:

Member Contrast Ratio=1−(1/front contrast ratio A−1/front contrast ratio B).

Further, the member contrast ratio of the front substrate to the rear substrate (member contrast ratio of front substrate/member contrast ratio of rear substrate) of each liquid-crystal cell was computed. The contrast ratio of Liquid-crystal Cell 1 was 13.5; that of Liquid-crystal Cell 2 was 0.5; that of Liquid-crystal Cell 3 was 54.5; that of Liquid-crystal Cell 4 was 1.1; and that of Liquid-crystal Cells 5 and 6 was 50.2.

### (3) Production of VA-Mode Liquid-Crystal Display Devices:

Any of the above-produced six types of liquid-crystal cells (COA-structured Liquid-crystal Cell 1 of KDL-52W5; non-COA-structured Liquid-crystal Cells 2 and 4; COA-structured Liquid-crystal Cells 3, 5 and 6) was selected, and a polarizer was stuck to the outer surface of both substrates of the cell as indicated in the following Table, thereby producing a VA-mode liquid-crystal display device. The polarizers were so stuck that the absorption axes thereof could be perpendicular to each other.

### (4) Evaluation of VA-Mode Liquid-Crystal Display Devices:

Thus produced, the liquid-crystal display devices were evaluated as follows:

### (4)-1 Measurement of Normalized Front Contrast Ratio:

Using a tester BMSA (by TOPCON) in a dark room, the brightness at the time of black level and white level of display in the normal direction to the panel was measured, and from the data, the front contrast ratio (white brightness/black brightness) was computed. In this, the distance between the tester and the panel was 700 mm.

Subsequently, the normalized front contrast ratio was computed according to the following formula, based on the front contrast ratio in a standard state.

Normalized Front Contrast Ratio=(front contrast ratio in sample state)/(front contrast ratio in standard state).

The control was the liquid-crystal display device of Comparative Example 8 for those where the liquid-crystal cell 1 was used; it was the liquid-crystal display device of Comparative Example 4 for those where the liquid-crystal cell 2 or 3 was used; it was the liquid-crystal display device of Comparative Example 14 for those where the liquid-crystal cell 4 or 5 was used; and it was the liquid-crystal display device of Comparative Example 17 for those where the liquid-crystal cell 6 was used. The front contrast ratio was 3700 in Comparative Example 8, 2900 in Comparative Example 4, 3250 in Comparative Example 14, and 2650 in Comparative Example 17.

### (4)-2 Viewing Angle Contrast Ratio (Oblique Contrast Ratio):

Using a tester, BMSA (by TOPCON) in a dark room, the degree of light leakage at the time of black level of display was measured at an azimuth angle of 45 degrees and a polar angle of 60 degrees from the front of the device. The device having a small value of the degree has a smaller light leakage at an oblique direction of 45 degrees, and has a better display contrast ratio, from which, therefore, the viewing angle characteristic of the liquid-crystal display device can be evaluated.

A: No light leakage.
B: Slight light leakage, but acceptable.
C: Great light leakage, and unacceptable.

The evaluation based on the ratio of light leakage can be replaced for the viewing angle contrast ratio, or that is, the evaluation of no light leakage corresponds to a viewing angle contrast ratio of at least 50, and the evaluation of unacceptable great light leakage corresponds to a viewing angle contrast ratio of less than 25.

### (4)-3 Circular Unevenness:

The produced panel was left in an environment at a temperature of 40° C. and a relative humidity of 90% for 4 days. After thus processed, this was transferred into an environment at a temperature of 36° C. and a relative humidity of 30%.

Afterwards, the panel was put on a lighted light table, and the light leakage for 30 hours was observed in a dark room. The panel was evaluated for the circular unevenness according to the standards mentioned below.

A: No circular unevenness.
B: Slight circular unevenness, but acceptable.
C: Great circular unevenness, and unacceptable.

The unacceptable light leakage corresponds to the strong light leakage that does not disappear even in 60 hours after the panel is kept put on the lighted light table.

### (4)-4 Front Discoloration at the Time of Black Level of Display:

Using a tester BMSA (by TOPCON) in a dark room, the discoloration at the time of black level of display in the panel normal direction was checked, and bluish discoloration was noted. Accordingly, the front black color was evaluated based on the value v′ indicating bluish discoloration. In this, the distance between the tester and the panel was 700 mm.

A: v′ is at least 0.38 with no front bluish discoloration.
B: v′ is from 0.375 to less than 0.38 with slight front bluish discoloration but acceptable.
C: v′ is less than 0.375 with unacceptable great front bluish discoloration.

The results are shown in the following Table.

TABLE 12

| | | F-side | | R-side | | Normalized | Viewing | |
|---|---|---|---|---|---|---|---|---|
| | F-side | Film *2 | | Film *2 | R-side | front CR | angle | Circular |
| | Film *1 | (Rth) | Cell | (Rth) | Film *3 | (%) | CR | Unevenness |
| Example | Film 2 | Film 4 | Cell 3 | Film 1 | Film 2 | 121 | A | A |
| 1 | | (250 nm) | (COA) | (−1 nm) | | | | |
| Example | Film 2 | Film 10 | Cell 3 | Film 11 | Film 2 | 102 | A | B |
| 2 | | (165 nm) | (COA) | (90 nm) | | | | |
| Example | Film 2 | Film 4 | Cell 1 | Film 1 | Film 2 | 121 | A | A |
| 3 | | (250 nm) | (COA) | (−1 nm) | | | | |
| Example | Film 2 | Film 4 | Cell 1 | Film 3 | Film 2 | 121 | A | A |
| 4 | | (250 nm) | (COA) | (1.5 nm) | | | | |
| Example | Film 2 | Film 9 | Cell 1 | Film 1 | Film 2 | 121 | A | A |
| 5 | | (250 nm) | (COA) | (−1 nm) | | | | |
| Example | Film 2 | Film 5 | Cell 1 | Film 1 | Film 2 | 121 | B | A |
| 6 | | (205 nm) | (COA) | (−1 nm) | | | | |
| Example | Film 2 | Film 5 | Cell 1 | Film 2 | Film 2 | 117 | A | B |
| 7 | | (205 nm) | (COA) | (45 nm) | | | | |
| Example | Film 2 | Film 7 | Cell 1 | Film 2 | Film 2 | 117 | A | B |
| 8 | | (208 nm) | (COA) | (45 nm) | | | | |
| Example | Film 2 | Film 8 | Cell 1 | Film 2 | Film 2 | 117 | A | B |
| 9 | | (205 nm) | (COA) | (45 nm) | | | | |
| Example | Film 2 | Film 6 | Cell 1 | Film 2 | Film 2 | 117 | B | B |
| 10 | | (200 nm) | (COA) | (45 nm) | | | | |
| Example | Film 2 | Film 4 | Cell 1 | Film 17 | Film 2 | 121 | A | A |
| 11 | | (250 nm) | (COA) | (3.1 nm) | | | | |
| Example | Film 2 | Film 4 | Cell 1 | Film 18 | Film 2 | 121 | A | A |
| 12 | | (250 nm) | (COA) | (3.1 nm) | | | | |
| Example | Film 2 | Film 14 | Cell 1 | Film 13 | Film 2 | 122 | A | — |
| 13 | | (250 nm) | (COA) | (−69 nm) | | | | |
| Example | Film 2 | Film 15 | Cell 1 | Film 1 | Film 2 | 121 | A | A |
| 14 | | (250 nm) | (COA) | (−1 nm) | | | | |
| Example | Film 2 | Film 5 | Cell 1 | Film 16 | Film 2 | 117 | A | B |
| 15 | | (205 nm) | (COA) | (45 nm) | | | | |
| Example | Film 2 | Film 5 | Cell 1 | Film 16 | Film 16 | 117 | A | — |
| 16 | | (205 nm) | (COA) | (45 nm) | | | | |
| Example | Film 16 | Film 5 | Cell 1 | Film 16 | Film 2 | 117 | A | — |
| 17 | | (205 nm) | (COA) | (45 nm) | | | | |
| Example | Film 16 | Film 5 | Cell 1 | Film 16 | Film 16 | 117 | A | B |
| 18 | | (205 nm) | (COA) | (45 nm) | | | | |
| Example | Film 2 | Film 4 | Cell 5 | Film 1 | Film 2 | 121 | A | A |
| 19 | | (250 nm) | (COA) | (−1 nm) | | | | |
| Example | Film 2 | Film 5 | Cell 5 | Film 2 | Film 2 | 117 | A | B |
| 20 | | (205 nm) | (COA) | (45 nm) | | | | |
| Example | Film 2 | Film 10 | Cell 5 | Film 11 | Film 2 | 102 | A | B |
| 21 | | (165 nm) | (COA) | (90 nm) | | | | |
| Example | Film 2 | Film 5 | Cell 6 | Film 1 | Film 2 | 121 | A | A |
| 22 | | (205 nm) | (COA) | (−1 nm) | | | | |
| Example | Film 2 | Film 10 | Cell 6 | Film 2 | Film 2 | 117 | A | B |
| 23 | | (165 nm) | (COA) | (45 nm) | | | | |
| Example | Film 2 | Film 5 | Cell 1 | Film 20 | Film 2 | 115 | A | B |
| 24 | | (205 nm) | (COA) | (53 nm) | | | | |

*1-3: “F-side” means front-side, and “R-side” means rear-side.

TABLE 13

| | | F-side | Liquid | R-side | | Normalized | Viewing | |
|---|---|---|---|---|---|---|---|---|
| | F-side | Film *2 | crystal | Film *2 | R-side | Front CR | angle | Circular |
| | Film *1 | (Rth) | Cell | (Rth) | Film *3 | (%) | CR | Unevenness |
| Comparative | Film 2 | Film 4 | Cell 2 | Film 1 | Film 2 | 94 | A | B |
| Example1 | | (250 nm) | (non- | (−1 nm) | | | | |
| | | | COA) | | | | | |
| Comparative | Film 2 | Film 10 | Cell 2 | Film 11 | Film 2 | 99 | A | C |
| Example2 | | (165 nm) | (non- | (90 nm) | | | | |
| | | | COA) | | | | | |
| Comparative | Film 2 | Film 10 | Cell 2 | Film 12 | Film 2 | 101 | A | C |
| Example3 | | (165 nm) | (non- | (95 nm) | | | | |
| | | | COA) | | | | | |
| Comparative | Film 2 | Film 10 | Cell 3 | Film 12 | Film 2 | 100 | A | B |
| Example4 | | (165 nm) | (COA) | (95 nm) | | | | |
| Comparative | Film 2 | Film 2 | Cell 1 | Film 5 | Film 2 | 87 | A | C |
| Example5 | | (45 nm) | (COA) | (205 nm) | | | | |
| Comparative | Film 2 | Film 2 | Cell 1 | Film 7 | Film 2 | 87 | A | C |
| Example6 | | (45 nm) | (COA) | (208 nm) | | | | |
| Comparative | Film 2 | Film 1 | Cell 1 | Film 4 | Film 2 | 83 | A | C |
| Example7 | | (−1 nm) | (COA) | (250 nm) | | | | |
| Comparative | Film 2 | Film 10 | Cell 1 | Film 12 | Film 2 | 100 | A | B |
| Example8 | | (165 nm) | (COA) | (95 nm) | | | | |
| Comparative | Film 2 | Film 4 | Cell 4 | Film 1 | Film 2 | 94 | A | B |
| Example9 | | (250 nm) | (non- | (−1 nm) | | | | |
| | | | COA) | | | | | |
| Comparative | Film 2 | Film 5 | Cell 4 | Film 2 | Film 2 | 96 | A | C |
| Example10 | | (205 nm) | (non- | (45 nm) | | | | |
| | | | COA) | | | | | |
| Comparative | Film 2 | Film 10 | Cell 4 | Film 11 | Film 2 | 99 | A | C |
| Example11 | | (165 nm) | (non- | (90 nm) | | | | |
| | | | COA) | | | | | |
| Comparative | Film 2 | Film 2 | Cell 4 | Film 5 | Film 2 | 99 | A | — |
| Example12 | | (45 nm) | (non- | (205 nm) | | | | |
| | | | COA) | | | | | |
| Comparative | Film 2 | Film 1 | Cell 4 | Film 4 | Film 2 | 98 | A | — |
| Example13 | | (−1 nm) | (non- | (250 nm) | | | | |
| | | | COA) | | | | | |
| Comparative | Film 2 | Film 10 | Cell 5 | Film 12 | Film 2 | 100 | A | — |
| Example14 | | (165 nm) | (COA) | (95 nm) | | | | |
| Comparative | Film 2 | Film 2 | Cell 5 | Film 5 | Film 2 | 87 | A | C |
| Example15 | | (45 nm) | (COA) | (205 nm) | | | | |
| Comparative | Film 2 | Film 1 | Cell 5 | Film 4 | Film 2 | 83 | A | — |
| Example16 | | (−1 nm) | (COA) | (250 nm) | | | | |
| Comparative | Film 2 | Film 19 | Cell 6 | Film 12 | Film 2 | 100 | A | B |
| Example17 | | (110 nm) | (COA) | (95 nm) | | | | |
| Comparative | Film 2 | Film 10 | Cell 1 | Film 21 | Film 2 | 98 | A | — |
| Example18 | | (165 nm) | (COA) | (97 nm) | | | | |

*1-3: “F-side” means front-side, and “R-side” means rear-side.

From the above results, it is understood that the VA-mode liquid-crystal display devices of Examples of the invention where the retardation film satisfying the above formula (I) is disposed between the rear-side polarizing element and the COA-structured liquid-crystal cell all have a high front contrast ratio. Concretely, when the front CR of Examples 1 and 2 is compared with the front CR of Comparative Examples 1 and 2 having the same constitution as that of Examples 1 and 2, respectively, except that the former have a non-COA-structured liquid-crystal cell, then it is understood that the VA-mode liquid-crystal display devices of the invention are remarkably excellent as compared with the non-COA-structured VA-mode liquid-crystal display devices in point of the front CR.

Further, Comparative Examples 4 and 3 are compared with each other. These are liquid-crystal display devices having the same constitution except that the liquid-crystal cell therein differs in that it is a COA structure or a non-COA structure; and the same relationship between Example 1 and Comparative Example 1 and the same relationship between Example 2 and Comparative Example 2 could apply to them. However, in Comparative Example 4, Rth(590) in the rear-side retardation region is 95 nm, not satisfying the formula (I), |Rth(590)|≦90 nm, and therefore the front CR of the device is rather low as compared with that in Comparative Example 3. From this, it is understandable that the effect of the invention is attained only when the COA structure is employed in the device and when the rear-side retardation region therein satisfies the above formula (I).

Further, Example 3 and Comparative Example 7; Example 7 and Comparative Example 5; and Example 8 and Comparative Example 6 are COA-structured VA-mode liquid-crystal display devices having the same constitution except that the rear-side retardation film and the front-side retardation film were replaced with each other. However, in Comparative Examples, Rth of the rear-side retardation film is high and does not satisfy the above formula (I), and therefore, it is understood that in these, the front CR is not improved but is rather lowered even though the COA structure is employed and the numerical aperture is expanded.

Among Examples, the VA-mode liquid-crystal display devices of Examples 1, 3 to 6, 11, 12, 14, 19 and 22 of the invention where the retardation film satisfying the above formula (Ia) is disposed between the rear-side polarizing element and the COA-structured liquid-crystal cell are especially excellent in point of not only the high front CR but also the absence of circular unevenness.

On the other hand, it is understood that the VA-mode liquid-crystal display devices of Examples 7 to 10, 15 to 18, 20 and 21 of the invention where the retardation film satisfying the above formula (Ib) is disposed between the rear-side polarizing element and the COA-structured liquid-crystal cell are excellent in the viewing angle CR even though Rth of the film disposed as the front-side retardation film is 200 nm or so. Accordingly, it is understood that the embodiment where the retardation film satisfying the above formula (Ib) is disposed between the rear-side polarizing element and the COA-structured liquid-crystal cell is excellent not only in the high front CR but also the total producibility including the front-side retardation film.

In the above Examples, Film 2, or that is a commercial TAC film, or Film 16 was used as the front-side and rear-side outer protective film; however, as the front-side and/or rear-side outer protective film, for example, any other cellulose acylate film (e.g., cellulose propionate, cellulose butyrate or the like film), or any other film comprising, as the main ingredient thereof, any of polyolefin (e.g., norbornene-based polymer), poly(meth)acrylate (e.g., polymethyl methacrylate), polycarbonate, polyester or polysulfone can also be used to attain the same effect; and any other commercial polymer film (Arton (by JSR) or Zeonoa (by Nippon Zeon) or the like norbornene-based polymer film) may also be used to attain the same effect.

### Reference Example

A VA-mode liquid-crystal display device was constructed in the same manner as in Example 3, for which, however, Film 1 was used in place of Film 4 as the front-side retardation film, and this was evaluated in the same manner therein. As a result, the normalized front contrast ratio was 121% and was high like in Examples, and the device was good as free from the problem of circular unevenness; however, the viewing angle contrast ratio of the device was low. The reason may be because the optical characteristics of Film 1 used as the front-side retardation film would be insufficient for compensation for the viewing angle characteristics of the VA-mode liquid-crystal display device.

The following Table shows the results in evaluation of the front discoloration at the time of black level of display.

TABLE 14

| | | | Liquid | R-side | | Normalized | Front | Viewing |
|---|---|---|---|---|---|---|---|---|
| | F-side | F-side | Crystal | Film *2 | R-side | Front CR | Discoloration | angle |
| | Film *1 | Film *2 | Cell | (Rth) | Film *3 | (%) | (v′) | CR |
| Example | Film 2 | Film 24 | Cell 5 | Film 22 | Film 2 | 117 | B | — |
| 25 | | (R *4) | (COA) | (41 nm N *4) | | | (0.375) | |
| Example | Film 2 | Film 24 | Cell 5 | Film 23 | Film 2 | 117 | A | — |
| 26 | | (R *4) | (COA) | (43 nm F *4) | | | (0.381) | |
| Example | Film 2 | Film 24 | Cell 5 | Film 2 | Film 2 | 117 | A | 69 |
| 27 | | (R *4) | (COA) | (45 nm R *4) | | | (0.385) | |
| Example | Film 2 | Film 7 | Cell 5 | Film 2 | Film 2 | 117 | — | 68 |
| 28 | | (F *4) | (COA) | (45 nm R *4) | | | | |
| Example | Film 2 | Film 25 | Cell 5 | Film 2 | Film 2 | 117 | — | 67 |
| 29 | | (N *4) | (COA) | (45 nm R *4) | | | | |
| Comparative | Film 2 | Film 24 | Cell 4 | Film 22 | Film 2 | 96 | C | — |
| Example | | (R *4) | (non- | (41 nm N *4) | | | | |
| 19 | | | COA) | | | | | |
| Comparative | Film 2 | Film 24 | Cell 4 | Film 23 | Film 2 | 96 | C | — |
| Example | | (R *4) | (non- | (43 nm F *4) | | | | |
| 20 | | | COA) | | | | | |
| Comparative | Film 2 | Film 24 | Cell 4 | Film 2 | Film 2 | 96 | C | 65 |
| Example | | (R *4) | (non- | (45 nm R *4) | | | | |
| 21 | | | COA) | | | | | |
| Comparative | Film 2 | Film 7 | Cell 4 | Film 2 | Film 2 | 96 | — | 65 |
| Example | | (F *4) | (non- | (45 nm R *4) | | | | |
| 22 | | | COA) | | | | | |
| Comparative | Film 2 | Film 25 | Cell 4 | Film 2 | Film 2 | 96 | — | 64 |
| Example | | (N *4) | (non- | (45 nm R *4) | | | | |
| 23 | | | COA) | | | | | |
| Comparative | Film 2 | Film 2 | Cell 5 | Film 24 | Film 2 | 87 | C | 62 |
| Example | | (R *4) | (COA) | (210 nm R *4) | | | | |
| 24 | | | | | | | | |

*4: the symbol indicates the wavelength-dispersion of Re and Rth, and “R” means that Re andRth show reversed wavelength-dispersion, “F” means that Re and Rth are constant with wavelength variation, and “N” means that Re and Rth show normal wavelength-dispersion.

### Comparison Between Examples 25 to 27 and Comparative Examples 19 and 21

From the results shown in the above Table, it is understood that, in the liquid-crystal display devices in Examples 25 to 27 having a COA-structured liquid-crystal cell, in case where the retardation film used for the rear-side retardation region satisfies the formula (I) and where the film has reversed wavelength dispersion characteristics of retardation, not only the front CR but also the front black state of the devices can be improved. Concretely, it is understood that, in case where the retardation film used for the rear-side retardation region has reversed wavelength dispersion characteristics of retardation, then v′ increases and therefore the front bluish discoloration at the time of black level of display can be reduced and the black state can be enhanced.

### Comparison Between Examples 27 to 29 and Comparative Examples 21 to 2

From the results shown in the above Table, it is understood that the liquid-crystal display devices in Examples 27 to 29 having a COA-structured liquid-crystal cell are improved not only in the front CR but also in the viewing angle CR, as compared with those in Comparative Examples 21 to 23 having the same constitution but having a non-COA-structured liquid-crystal cell. In Comparative Example 24, though the device comprises a COA-structured liquid-crystal cell, both the front CR and the viewing angle CR thereof are not improved. From this, it is understood that the effect is not one attained by the use of the COA-structured liquid-crystal cell. The viewing angle CR-increasing effect is attained by making the rear-side retardation region in the COA structure have a low retardation whereby the scattering of the incident polarized light having entered the liquid-crystal cell is retarded, like the front CR-increasing effect.

Examples 27 to 29 are compared with each other in point of the viewing angle CR thereof. It is understood that, in case where the front-side retardation region has a retardation on the same level (for example, Re is from 30 to 90 nm or so, and Rth is from 180 to 300 nm or so), it is the best that the front-side retardation region has reversed wavelength dispersion characteristics of retardation, from the viewpoint of the viewing angle CR, and next, it is better that the retardation in the region is constant irrespective of wavelength.

Specifically, from the above results, it is understood that, when the rear-side retardation region of a COA-structured liquid-crystal cell is made to have a low retardation satisfying the formula (I), then not only the front CR but also the viewing angle CR can be improved, that, when the rear-side retardation region has reversed wavelength dispersion characteristics of retardation, then the front bluish expression can be improved, and that, when the front-side retardation region has reversed wavelength dispersion characteristics of retardation, then the viewing angle characteristics such as typically the viewing angle CR can be improved.

### Examples 30 to 32

Subsequently, the light source was changed and the front contrast ratio was evaluated.

As the light source, used was the backlight used in the following three liquid-crystal panels:

(i) Mitsubishi's liquid-crystal panel, LCD-40MZW100,
(ii) Sharp's liquid-crystal panel, LC-37GX3W,
(iii) Sharp's liquid-crystal panel, LC-32DE5.

The light source (i) comprises one prism sheet; and the light source (iii) comprises two prism sheets. The light source (ii) comprises one lens array sheet with a diffuser stuck thereto, in which a light-reflecting layer is formed on the flat surface of the opposite side of the lens array sheet in the non-light-focusing region of the lens therein. In the evaluation test, used were the COA-structured liquid-crystal display devices of Example 20 and Comparative Example 15. The light source was changed as above, and the front contrast ratio of these devices was measured.

According to the following formula, the progress rate of front contrast ratio was determined.

Progress rate of Front Contrast Ratio(%)=(front contrast ratio of the device of Example 20−front contrast ratio of the device of Comparative Example 15)/(front contrast ratio of control device).

In this, the control device is the liquid-crystal display device of Comparative Example 14, and the front contrast ratio of the control device was measured with the light source of LCD-40MZW100.

The results are shown in the following Table.

TABLE 15

| | | | Directivity of Light source*2 | | | |
|---|---|---|---|---|---|---|
| | | | Polar Angle 45° | | | |
| | | | Azi- | Azi- | Azi- | Progress |
| | | | muth | muth | muth | rate of |
| | Light | Direc- | angle | Angle | angle | Front CR |
| | Source | tivity | 0° | 45° | 90° | (%) |
| Example | (i) | W*1 | 0.64 | 0.43 | 0.31 | 30 |
| 30 | | ↓ | | | | |
| Example | (ii) | S*1 | 0.63 | 0.38 | 0.32 | 33 |
| 31 | | | | | | |
| Example | (iii) | | 0.28 | 0.32 | 0.32 | 37 |
| 32 | | | | | | |

*1“W” means weak and “S” means strong.
*2The ratio of the oblique brightness to the front brightness.

From the results in the above Table, it is understood that, when the directivity of the light source is higher, then the progress rate of front contrast ratio of the devices of Examples of the invention is larger. It is anticipated that the front contrast-increasing effect demonstrated in the invention will be more remarkable in high-contrast panels that may be provided in future.

1. A VA-mode liquid-crystal display device comprising a front-side polarizing element, a rear-side polarizing element, a liquid-crystal layer disposed between the front-side polarizing element and the rear-side polarizing element, and a color filter disposed between the liquid-crystal layer and the rear-side polarizing element, wherein one or more retardation layers disposed between the rear-side polarizing element and the color filter layer (hereinafter the whole of one or more retardation layers disposed between the rear-side polarizing element and the color filter layer is referred to as “rear-side retardation region”) satisfies, as a whole, the following formula (I):

|Rth(590)|≦90 nm, (I)
wherein Rth(λ) means a retardation (nm) in the thickness direction at a wavelength of λ nm.

2. The VA-mode liquid-crystal display device of claim 1, wherein the liquid-crystal layer is sandwiched between an array substrate having a black matrix that partitions the pixel having the color filter layer, and the counter substrate disposed to face the array substrate.

3. The VA-mode liquid-crystal display device of claim 1, wherein the rear-side retardation region satisfies the following formula (II):

|Re(590)|≦20 nm (II)
wherein Re(λ) means an in-plane retardation (nm) at a wavelength of λ nm.

4. The VA-mode liquid-crystal display device of claim 1, wherein one or more retardation layers disposed between the front-side polarizing element and the liquid-crystal layer (hereinafter the whole of one or more retardation layers disposed between the front-side polarizing element and the liquid-crystal layer is referred to as “front-side retardation region”) satisfies, as a whole, the following formulae (III) and (IV):
30 nm≦Re(590)≦90 nm, (III)
150 nm≦Rth(590)≦300 nm. (IV)

5. The VA-mode liquid-crystal display device of claim 1, wherein the rear-side retardation region satisfies the following formula (Ia):

|Rth(590)|≦20 nm. (Ia)

6. The VA-mode liquid-crystal display device of claim 5, wherein the front-side retardation region satisfies the following formulae (Ma) and (IVa):
30 nm≦Re(590)≦90 nm, (IIIa)
180 nm≦Rth(590)≦300 nm. (IVa)

7. The VA-mode liquid-crystal display device of claim 1, wherein the rear-side retardation region satisfies the following formula (Ib):
20 nm<Rth(590)≦90 nm. (Ib)

8. The VA-mode liquid-crystal display device of claim 7, wherein the front-side retardation region satisfies the following formulae (IIIb) and (IVb):
30 nm≦Re(590)≦90 nm, (IIIb)
150 nm≦Rth(590)≦270 nm. (IVb)

9. The VA-mode liquid-crystal display device of claim 1, wherein the rear-side retardation region is formed of a cellulose acylate film or comprises a cellulose acylate film.

10. The VA-mode liquid-crystal display device of claim 1, wherein the rear-side retardation region is formed of an acrylic polymer film or comprises an acrylic polymer film.

11. The VA-mode liquid-crystal display device of claim 10, wherein the rear-side retardation region is formed of an acrylic polymer film containing an acrylic polymer containing at least one unit selected from a lactone ring unit, a maleic anhydride unit, and a glutaric anhydride unit, or comprises that type of an acrylic polymer film.

12. The VA-mode liquid-crystal display device of claim 1, wherein the rear-side retardation region is formed of a cyclic olefin polymer film or comprises a cyclic olefin polymer film.

13. The VA-mode liquid-crystal display device of claim 1, wherein the front-side retardation region is formed of one biaxial polymer film or comprises one biaxial polymer film.

14. The VA-mode liquid-crystal display device of claim 1, wherein the front-side retardation region comprises one monoaxial polymer film.

15. The VA-mode liquid-crystal display device of claim 13, wherein the biaxial polymer film or the monoaxial polymer film is a cellulose acylate film.

16. The VA-mode liquid-crystal display device of claim 13, wherein the biaxial polymer film or the monoaxial polymer film is a cyclic olefin polymer film.

17. The VA-mode liquid-crystal display device of claim 1, wherein Re and Rth of the rear-side retardation region have reversed wavelength dispersion characteristics of retardation or are constant irrespective of wavelength, in a visible light wavelength region.

18. The VA-mode liquid-crystal display device of claim 14, wherein the biaxial polymer film or the monoaxial polymer film is a cellulose acylate film.

19. The VA-mode liquid-crystal display device of claim 14, wherein the biaxial polymer film or the monoaxial polymer film is a cyclic olefin polymer film.
